(19) United States
(12) Patent Application Publication
(10) Pub. No.: US 2022/0167025 A1
(43) Pub. Date: May 26, 2022

(54) METHOD, DEVICE, AND COMPUTER PROGRAM FOR OPTIMIZING TRANSMISSION OF PORTIONS OF ENCAPSULATED MEDIA CONTENT

(71) Applicant: CANON KABUSHIKI KAISHA, Tokyo (JP)

(72) Inventors: Franck DENOUAL, SAINT DOMINEUC (FR); Frédéric MAZE, LANGAN (FR); Naël OUEDRAOGO, VAL D'ANAST (FR)

(21) Appl. No.: 17/433,963

(22) PCT Filed: Mar. 2, 2020
(86) PCT No.: PCT/EP2020/055467

§ 371 Date: Aug. 25, 2021

(30) Foreign Application Priority Data
Mar. 8, 2019 (GB) 1903134.3
Jun. 26, 2019 (GB) 1909205.5

(51) Int. Cl. H04N 21/235; H04N 21/845; H04N 21/854; H04N 21/435

(52) U.S. Cl. CPC H04N 21/2353; H04N 21/8456; H04N 21/435; H04N 21/854; H04N 21/8455

(57) ABSTRACT

A method for receiving encapsulated media data provided by a server, the encapsulated media data comprising metadata and data associated with the metadata, the metadata being descriptive of the associated data, the method being carried out by the client and obtaining, from the server, metadata associated with actual data; and in response to obtaining the metadata, requesting a portion of the actual data associated with the obtained metadata, wherein the actual data are requested independently from all the metadata with which they are associated.

### FIELD OF THE INVENTION

The present invention relates to a method, a device, and a computer program for improving encapsulating and parsing of media data, making it possible to optimize transmission of portions of encapsulated media content.

### BACKGROUND OF THE INVENTION

The invention relates to encapsulating, parsing, and streaming media content, e.g. according to ISO Base Media File Format as defined by the MPEG standardization organization, to provide a flexible and extensible format that facilitates interchange, management, editing, and presentation of group of media content and to improve its delivery for example over an IP network such as the Internet using adaptive http streaming protocol.

The International Standard Organization Base Media File Format (ISO BMFF, ISO/IEC 14496-12) is a well-known flexible and extensible format that describes encoded timed media data bit-streams either for local storage or transmission via a network or via another bit-stream delivery mechanism. This file format has several extensions, e.g. Part-15, ISO/IEC 14496-15 that describes encapsulation tools for various NAL (Network Abstraction Layer) unit based video encoding formats. Examples of such encoding formats are AVC (Advanced Video Coding), SVC (Scalable Video Coding), HEVC (High Efficiency Video Coding), or L-HEVC (Layered HEVC). This file format is object-oriented. It is composed of building blocks called boxes (or data structures, each of which being identified by a four character code) that are sequentially or hierarchically organized and that define descriptive parameters of the encoded timed media data bit-stream such as timing and structure parameters. In the file format, the overall presentation over time is called a movie. The movie is described by a movie box (with four character code ‘moov’) at the top level of the media or presentation file. This movie box represents an initialization information container containing a set of various boxes describing the presentation. It may be logically divided into tracks represented by track boxes (with four character code ‘trak’). Each track (uniquely identified by a track identifier (track_ID)) represents a timed sequence of media data pertaining to the presentation (frames of video, for example). Within each track, each timed unit of data is called a sample; this might be a frame of video, audio or timed metadata. Samples are implicitly numbered in sequence. The actual samples data are in boxes called Media Data Boxes (with four character code ‘mdaf’) at the same level as the movie box. The movie may also be fragmented, i.e. organized temporally as a movie box containing information for the whole presentation followed by a list of movie fragment and Media Data box pairs. Within a movie fragment (box with four-character code ‘moof’) there is a set of track fragments (box with four character code ‘traf’), zero or more per movie fragment. The track fragments in turn contain zero or more track run boxes (‘trun’), each of which documents a contiguous run of samples for that track fragment.

Media data encapsulated with ISOBMFF can be used for adaptive streaming with HTTP. For example, MPEG DASH (for “Dynamic Adaptive Streaming over HTTP”) and Smooth Streaming are HTTP adaptive streaming protocols enabling segment or fragment based delivery of media files. The MPEG DASH standard (see “ISO/IEC 23009-1, Dynamic adaptive streaming over HTTP (DASH), Part1: Media presentation description and segment formats”) makes it possible to establish a link between a compact description of the content(s) of a media presentation and the HTTP addresses. Usually, this association is described in a file called a manifest file or description file. In the context of DASH, this manifest file is a file also called the MPD file (for Media Presentation Description). When a client device gets the MPD file, the description of each encoded and deliverable version of media content can easily be determined by the client. By reading or parsing the manifest file, the client is aware of the kind of media content components proposed in the media presentation and is aware of the HTTP addresses for downloading the associated media content components. Therefore, it can decide which media content components to download (via HTTP requests) and to play (decoding and playing after reception of the media data segments). DASH defines several types of segments, mainly initialization segments, media segments, or index segments. Initialization segments contain setup information and metadata describing the media content, typically at least the ‘ftyp’ and ‘moov’ boxes of an ISOBMFF media file. A media segment contains the media data. It can be for example one or more ‘moof’ plus ‘mdat’ boxes of an ISOBMFF file or a byte range in the ‘mdat’ box of an ISOBMFF file. A media segment may be further subdivided into sub-segments (also corresponding to one or more complete ‘moof’ plus ‘mdat’ boxes). The DASH manifest may provide segment URLs or a base URL to the file with byte ranges to segments for a streaming client to address these segments through HTTP requests. The byte range information may be provided by index segments or by specific ISOBMFF boxes such as the Segment Index Box ‘sidx’ or the SubSegment Index Box ‘ssix’.

FIG. 1 illustrates an example of streaming media data from a server to a client.

As illustrated, a server 100 comprises an encapsulation module 105 connected, via a network interface (not represented), to a communication network 110 to which is also connected, via a network interface (not represented), a de-encapsulation module 115 of a client 120.

Server 100 processes data, e.g. video and/or audio data, for streaming or for storage. To that end, server 100 obtains or receives data comprising, for example, an original sequence of images 125, encodes the sequence of images into media data (i.e. bit-stream) using a media encoder (e.g. video encoder), not represented, and encapsulates the media data in one or more media files or media segments 130 using encapsulation module 105. Encapsulation module 105 comprises at least one of a writer or a packager to encapsulate the media data. The media encoder may be implemented within encapsulation module 105 to encode received data or may be separate from encapsulation module 105.

Client 120 is used for processing data received from communication network 110, for example for processing media file 130. After the received data have been de-encapsulated in de-encapsulation module 115 (also known as a parser), the de-encapsulated data (or parsed data), corresponding to a media data bit-stream, are decoded, forming, for example, audio and/or video data that may be stored, displayed or output. The media decoder may be implemented within de-encapsulation module 115 or it may be separate from de-encapsulation module 115. The media decoder may be configured to decode one or more video bit-streams in parallel.

It is noted that media file 130 may be communicated to de-encapsulation module 115 into different ways. In particular, encapsulation module 105 may generate media file 130 with a media description (e.g. DASH MPD) and communicates (or streams) it directly to de-encapsulation module 115 upon receiving a request from client 120.

For the sake of illustration, media file 130 may encapsulate media data (e.g. encoded audio or video) into boxes according to ISO Base Media File Format (ISOBMFF, ISO/IEC 14496-12 and ISO/IEC 14496-15 standards). In such a case, media file 130 may correspond to one or more media files (indicated by a FileTypeBox ‘ftyp’), as illustrated in FIG. 2a, or one or more segment files (indicated by a SegmentTypeBox ‘styp’), as illustrated in FIG. 2b. According to ISOBMFF, media file 130 may include two kinds of boxes, a “media data box”, identified as ‘mdat’, containing the media data and “metadata boxes” (e.g. ‘moof’) containing metadata defining placement and timing of the media data.

FIG. 2a illustrates an example of data encapsulation in a media file. As illustrated, media file 200 contains a ‘moov’ box 205 providing metadata to be used by a client during an initialization step. For the sake of illustration, the items of information contained in the ‘moov’ box may comprise the number of tracks present in the file as well as a description of the samples contained in the file. According to the illustrated example, the media file further comprises a segment index box ‘sidx’ 210 and several fragments such as fragments 215 and 220, each composed of a metadata part and a data part. For example, fragment 215 comprises metadata represented by ‘moof’ box 225 and data part represented by ‘mdaf’ box 230. Segment index box ‘sidx’ comprises an index making it possible directly to reach data associated with a particular fragment. It comprises, in particular, the duration and size of movie fragments.

FIG. 2b illustrates an example of data encapsulation as a media segment or as segments, being observed that media segments are suitable for live streaming. As illustrated, media segment 250 starts with the ‘styp’ box. It is noted that for using segments like segment 250, an initialization segment must be available, with a ‘moov’ box indicating the presence of movie fragments Omen the initialization segment comprising movie fragments or not. According to the example illustrated in FIG. 2b, media segment 250 contains one segment index box ‘sidx’ 255 and several fragments such as fragments 260 and 265. The ‘sidx’ box 255 typically provides the duration and size of the movie fragments present in the segment. Again, each fragment is composed of a metadata part and a data part. For example, fragment 260 comprises metadata represented by ‘moof’ box 270 and data part represented by ‘mdaf’ box 275.

FIG. 3 illustrates the segment index box ‘sidx’ represented in FIGS. 2a and 2b, as defined by ISO/IEC 14496-12 in a simple mode wherein an index provides durations and sizes for each fragment encapsulated in the corresponding file or segment. When the reference type field denoted 305 is set to 0, the simple index, described by the ‘sidx’ box 300, consists in a loop on the fragments contained in the segment. Each entry in the index (e.g. entries denoted 320 and 325) provides the size in bytes and the duration of a movie fragment as well as information on the presence and position of the random access point possibly present in the segment. For example, entry 320 in the index provides the size 310 and the duration 315 of movie fragment 330.

FIG. 4 illustrates requests and responses between a server and a client, as performed with DASH, to obtain media data. For the sake of illustration, it is assumed that the data are encapsulated in ISOBMFF and a description of the media components is available in a DASH Media Presentation Description (MPD).

As illustrated, a first request and response (steps 400 and 405) aim at providing the streaming manifest to the client, that is to say the media presentation description. From the manifest, the client can determine the initialization segments that are required to set up and initialize its decoder(s). Then, the client requests one or more of the initialization segments identified according to the selected media components through HTTP requests (step 410). The server replies with metadata (step 415), typically the ones available in the ISOBMFF ‘moov’ box and its sub-boxes. The client does the set-up (step 420) and may request index information from the server (step 425). This is the case for example in DASH profiles where Indexed Media Segments are in use, e.g. live profile. To achieve this, the client may rely on an indication in the MPD (e.g. indexRange) providing the byte range for the index information. When the media data are encapsulated according to ISOBMFF, the segment index information may correspond to the SegmentIndex box ‘sidx’. In the case according to which the media data are encapsulated according to MPEG-2 TS, the indication in the MPD may be a specific URL referencing an Index Segment.

Then, the client receives the requested segment index from the server (step 430). From this index, the client may compute byte ranges (step 435) to request movie fragments at a given time (e.g. corresponding to a given time range) or at a given position (e.g. corresponding to a random access point or a point the client is seeking). The client may issue one or more requests to get one or more movie fragments for the selected media components in the MPD (step 440). The server replies to the requested movie fragments by sending one or more sets comprising ‘moof’ and ‘mdaf’ boxes (step 445). It is observed that the requests for the movie fragments may be made directly without requesting the index, for example when media segments are described as segment template and no index information is available.

Upon reception of the movie fragments, the client decodes and renders the corresponding media data and prepares the request for the next time interval (step 450). This may consist in getting a new index, even sometimes in getting an MPD update or simply to request next media segments as indicated in the MPD (e.g. following a SegmentList or a SegmentTemplate description).

While these file formats and these methods for transmitting media data have proven to be efficient, there is a continuous need to improve selection of the data to be sent to a client while reducing the requested bandwidth and taking advantage of the increasing processing capabilities of the client devices.

The present invention has been devised to address one or more of the foregoing concerns.

### SUMMARY OF THE INVENTION

According to a first aspect of the invention there is provided a method for receiving encapsulated media data provided by a server, the encapsulated media data comprising metadata and data associated with the metadata, the metadata being descriptive of the associated data, the method being carried out by the client and comprising:
obtaining, from the server, metadata associated with data; and
in response to obtaining the metadata, requesting a portion of the data associated with the obtained metadata,
   wherein the data are requested independently from all the metadata with which they are associated.

Accordingly, the method of the invention makes it possible to select more appropriately the data to be sent from a server to a client, from a client perspective, for example in terms of network bandwidth and client processing capabilities, to adapt data streaming to client's needs. This is achieved by providing low-level indexing items of information, that can be obtained by a client before requesting media data.

According to embodiments, the method further comprises receiving the requested portion of the data associated with the obtained metadata, the data being received independently from all the metadata with which they are associated.

According to embodiments, the metadata and the data are organized in segments, the encapsulated media data comprising a plurality of segments.

According to embodiments, a least one segment comprises metadata and data associated with the metadata of the at least one segment for a given time range.

According to embodiments, the method further comprises obtaining index information, the obtained metadata associated with data being obtained as a function of the obtained index information.

According to embodiments, the index information comprises at least one pair of index, a pair of indexes enabling the client to locate separately metadata associated with data and the corresponding data.

According to embodiments, the index information further comprises a data reference to locate a first item of the corresponding data.

According to embodiments, the index information further comprises a plurality of data references, each of the data references making it possible to locate a first item of a part of the corresponding data.

According to embodiments, a data reference is a data reference offset or an item of information that makes it possible to identify a media file.

According to embodiments, the indexes of the pair of indexes are associated with different types of data among metadata, data, and data comprising both metadata and data.

According to embodiments, the data are organized in data portions, at least one data portion comprising data organized as groups of data, the pair of indexes enabling the client to locate separately metadata associated with data of the at least one data portion and the corresponding data, and the pair of indexes enabling the client to request separately data of groups of data of the at least one data portion.

According to embodiments, the obtained index information comprises at least one set of pointers, a pointer of the set of pointers pointing to the metadata, a pointer of the set of pointers pointing to at least one block of corresponding data, and a pointer of the set of pointers pointing to an item of index information different from the obtained index information.

According to embodiments, the obtained index information further comprises items of type information, the items of type information being descriptive of the nature of data pointed by pointers of the at least one set of pointers.

According to embodiments, the method further comprises obtaining description information of the encapsulated media data, the description information comprising location information for locating metadata associated with data, the metadata and the data being located independently.

According to embodiments, at least one segment of the plurality of segments comprises only metadata associated with data.

According to embodiments, at least one segment of the plurality of segments comprises only data, the at least one segment comprising only data corresponding to the at least one segment comprising only metadata associated with data.

According to embodiments, several segments of the plurality of segments comprise only data, the several segments comprising only data corresponding to the at least one segment comprising only metadata associated with data.

According to embodiments, the method further comprises receiving a description file, the description file comprising a description of the encapsulated media data and a plurality of links to access data of the encapsulated media data, the description file further comprising an indication that data can be received independently from all the metadata with which they are associated.

According to embodiments, the received description file further comprises a link for enabling the client to request the at least one segment of the plurality of segments comprising only metadata associated with data.

According to embodiments, the format of the encapsulated media data is of the ISOBMFF type, wherein the metadata descriptive of associated data belong to ‘moof’ boxes and the data associated with metadata belong to ‘mdaf’ boxes.

According to embodiments, the index information belongs to a ‘sidx’ box.

According to a second aspect of the invention there is provided a method for processing received encapsulated media data provided by a server, the encapsulated media data comprising metadata and data associated with the metadata, the metadata being descriptive of the associated data, the method being carried out by the client and comprising:
receiving encapsulated media data according to the method described above;
de-encapsulating the received encapsulated media data; and
processing the de-encapsulated media data.

Accordingly, the method of the invention makes it possible to select more appropriately the data to be sent from a server to a client, from a client perspective, for example in terms of network bandwidth and client processing capabilities, to adapt data streaming to client's needs. This is achieved by providing low-level indexing items of information, that can be obtained by a client before requesting media data.

According to a third aspect of the invention there is provided a method for transmitting encapsulated media data, the encapsulated media data comprising metadata and data associated with the metadata, the metadata being descriptive of the associated data, the method being carried out by a server and comprising:
transmitting, to a client, metadata associated with data; and
in response to a request received from the client for receiving a portion of the data associated with the transmitted metadata, transmitting the portion of the data associated with the transmitted metadata,
   wherein the data are transmitted independently from all the metadata with which they are associated.

Accordingly, the method of the invention makes it possible to select more appropriately the data to be sent from a server to a client, from a client perspective, for example in terms of network bandwidth and client processing capabilities, to adapt data streaming to client's needs. This is achieved by providing low-level indexing items of information, that can be obtained by a client before requesting media data.

According to a fourth aspect of the invention there is provided a method for encapsulating media data, the encapsulated media data comprising metadata and data associated with the metadata, the metadata being descriptive of the associated data, the method being carried out by a server and comprising:
determining a metadata indication; and
encapsulating the metadata and data associated with the metadata as a function of the determined metadata indication so that data can be transmitted independently from all the metadata with which they are associated.

Accordingly, the method of the invention makes it possible to select more appropriately the data to be sent from a server to a client, from a client perspective, for example in terms of network bandwidth and client processing capabilities, to adapt data streaming to client's needs. This is achieved by providing low-level indexing items of information, that can be obtained by a client before requesting media data.

According to embodiment, the metadata indication comprises index information, the index information comprising at least one pair of index, a pair of indexes enabling a client to locate separately metadata associated with data and the corresponding data.

According to embodiment, the metadata indication comprises description information, the description information comprising location information for locating metadata associated with data, the metadata and the data being located independently.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of streaming media data from a server to a client;

FIG. 2a illustrates an example of data encapsulation in a media file;

FIG. 2b illustrates an example of data encapsulation as a media segment or as segments;

FIG. 3 illustrates the segment index box ‘sidx’ represented in FIGS. 2a and 2b, as defined by ISO/IEC 14496-12 in a simple mode wherein an index provides durations and sizes for each fragment encapsulated in the corresponding file or segment;

FIG. 4 illustrates requests and responses between a server and a client, as performed with DASH, to obtain media data;

FIG. 5 illustrates an example of application aiming at combining several videos to obtain a bigger one according to embodiments of the invention;

FIG. 6 illustrates requests and responses between a server and a client to obtain media data according to embodiments of the invention;

FIG. 7 is a block diagram illustrating an example of steps carried out by a server to transmit data to a client according to embodiments of the invention;

FIG. 8 is a block diagram illustrating an example of steps carried out by a client to obtain data from a server according to embodiments of the invention;

FIG. 9a illustrates a first example of an extended segment index box ‘sidx’ according to embodiments of the invention;

FIG. 9b illustrates a second example of an extended segment index box ‘sidx’ according to embodiments of the invention;

FIG. 10a illustrates an example of a spatial segment index box ‘spix’ according to embodiments of the invention;

FIG. 10b illustrates an example of a combination of segment index box ‘sidx’ and spatial segment index box ‘spix’ according to embodiments of the invention;

FIG. 11a illustrates an example of an extended segment index box ‘sidx’ according to embodiments of the invention, enabling access to metadata and data that are not interleaved;

FIG. 11b illustrates an example of an extended segment index box ‘sidx’ according to embodiments of the invention, enabling access to metadata and to data parts that are not interleaved;

FIGS. 12a and 12b are examples of media files encapsulated with metadata and data for a given segment, fragment or sub-segment that are split each into their own encapsulated media file(s), wherein data parts are contiguous and not contiguous, respectively;

FIGS. 13a and 13b illustrate two examples of using a daisy-chain index in a segment index box ‘sidx’ to provide byte ranges for both metadata and data;

FIG. 14 illustrates requests and responses between a server and a client to obtain media data according to embodiments of the invention when the metadata and the actual data are split into different segments;

FIG. 15a is a block diagram illustrating an example of steps carried out by a server to transmit data to a client according to embodiments of the invention;

FIG. 15b is a block diagram illustrating an example of steps carried out by a client to obtain data from a server according to embodiments of the invention;

FIG. 16 illustrates an example of decomposition into “metadata-only” segments and “data-only” (or “media-data-only”) segments when considering for example tiled videos and tile tracks at different qualities or resolutions;

FIG. 17 illustrates an example of decomposition of media components into one metadata-only segment and one data-only segment per resolution level;

FIGS. 18a, 18b, and 18c illustrate examples of a metadata-only segments;

FIGS. 18d and 18e illustrate examples of “media-data-only” or “data-only” segments;

FIG. 19 illustrates an example of an MPD wherein a Representation allows a two-step addressing;

FIG. 20 illustrates an example of an MPD wherein a Representation is described as providing two-step addressing but also as providing backward compatibility by providing a single URL for the whole segment; and

FIG. 21 schematically illustrates a processing device configured to implement at least one embodiment of the present invention.

### DETAILED DESCRIPTION OF THE INVENTION

According to embodiments, the invention makes it possible to take advantage of tiled videos for adaptive streaming over HTTP, giving the possibility to clients to select and compose spatial parts (or tiles) of videos to obtain and render a video given the client context (for example in terms of available bandwidth and client processing capabilities). This is obtained by giving the possibility to a client to access selected metadata independently of the associated actual data (or payload), for example by using different indexes for metadata and for actual data or by using different segments for encapsulating metadata and actual data.

For the sake of illustration, many embodiments described herein are based on the HEVC standard or extensions thereof. However, embodiments of the invention also apply to other coding standards already available, such as AVC, or not yet available or developed, such as MPEG Versatile Video Coding (VVC) that is under specification. In particular embodiments, the video encoder supports tiles and can control the encoding to generate independently decodable tiles, tile sets or tile groups, also sometimes called Motion-Constrained tile sets.

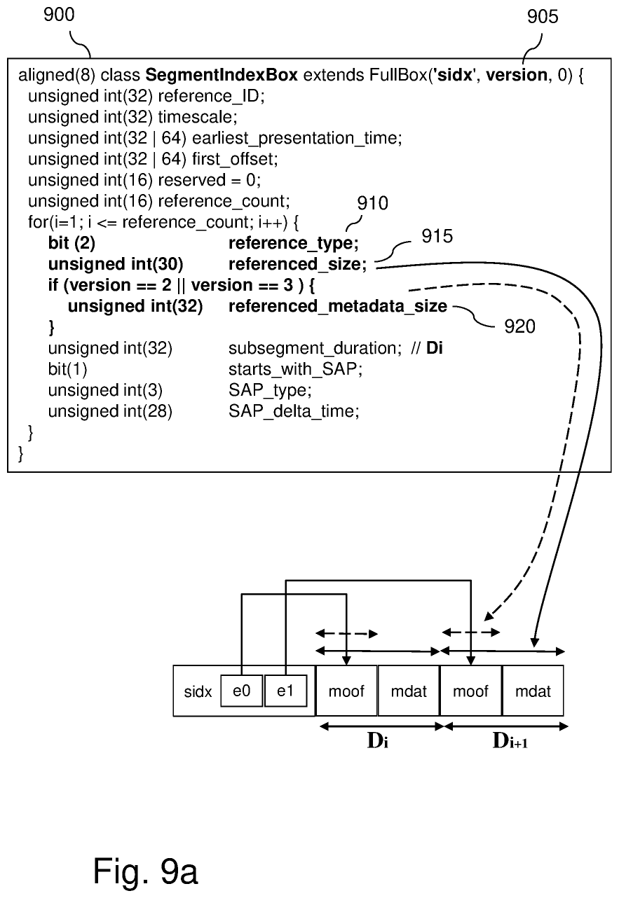

FIG. 5 illustrates an example of application aiming at combining several videos to obtain a bigger one according to embodiments of the invention. For the sake of illustration, it is assumed that four videos denoted 500 to 515 are available and that each of these videos is tiled, decomposed into spatial regions (four in the given examples). Naturally, it is to be understood that the decomposition may differ from one video to another (more or less tiles, different grid of tiles, etc.).

Depending on the use case, the videos 500 to 515 may represent the same content, e.g. recording of a same scene, but at different quality or resolution. This would be the case for example for viewport dependent streaming of immersive video like 360° video or videos recorded with very wide angle (e.g. 120° or more). For such a use case the video 520 resulting from the combination of portions of videos 500 to 515 typically consists in mixing the qualities or resolutions on a spatial region basis, so that the current user's point of view has the best quality.

In other use cases, for example for video mosaics or video compositions, the four videos 500 to 515 may correspond to different video content. For example, videos 500 and 505 may correspond to the same content but at different quality or resolution and videos 510 and 515 may correspond to another content also at different quality or resolution. This offers different combinations and then adaptation for the composed video 520. This adaptation is important because the data may be transmitted over non-managed networks where the bandwidth and/or the delay may vary over time. Therefore, generating granular media makes it possible to adapt the resulting video to the variations of the network conditions but also to client capabilities (it being observed that the content data are typically generated once for many potentially different clients such as PCs, TVs, tablets, smartphones, HMDs, wearable devices with small screens, etc.).

A media decoder may handle, combine, or compose tiles at different levels into a single bit-stream. A media decoder may rewrite parts of the bit-stream when tile positions in the composed bit-stream differ from their original position. For that, the media decoder may rely on specific piece of video data providing header information describing the original position. For example, when tiles are encoded as HEVC tile tracks, a specific NAL unit providing the slice header length may be used to obtain information on the original position of a tile.

Using different indexes for accessing metadata and for actual data encapsulated in the same segments

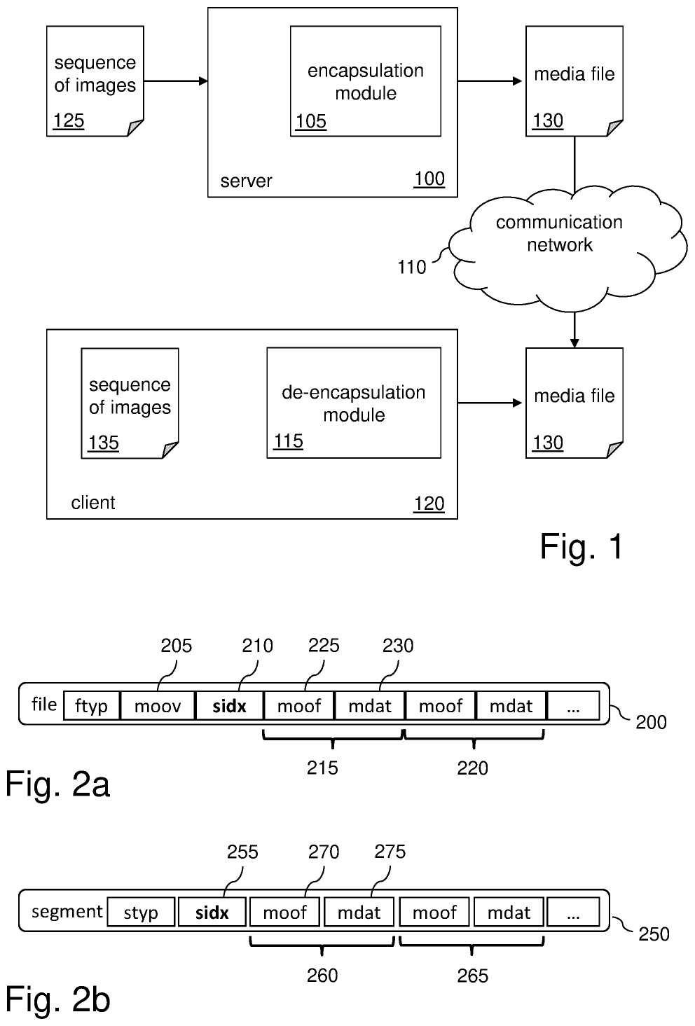

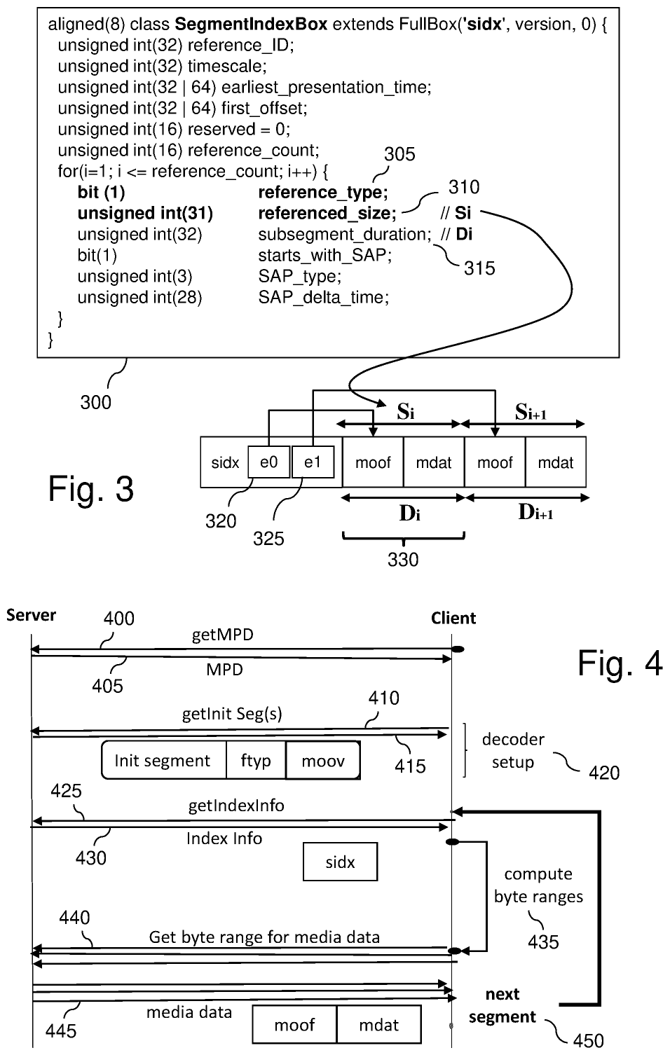

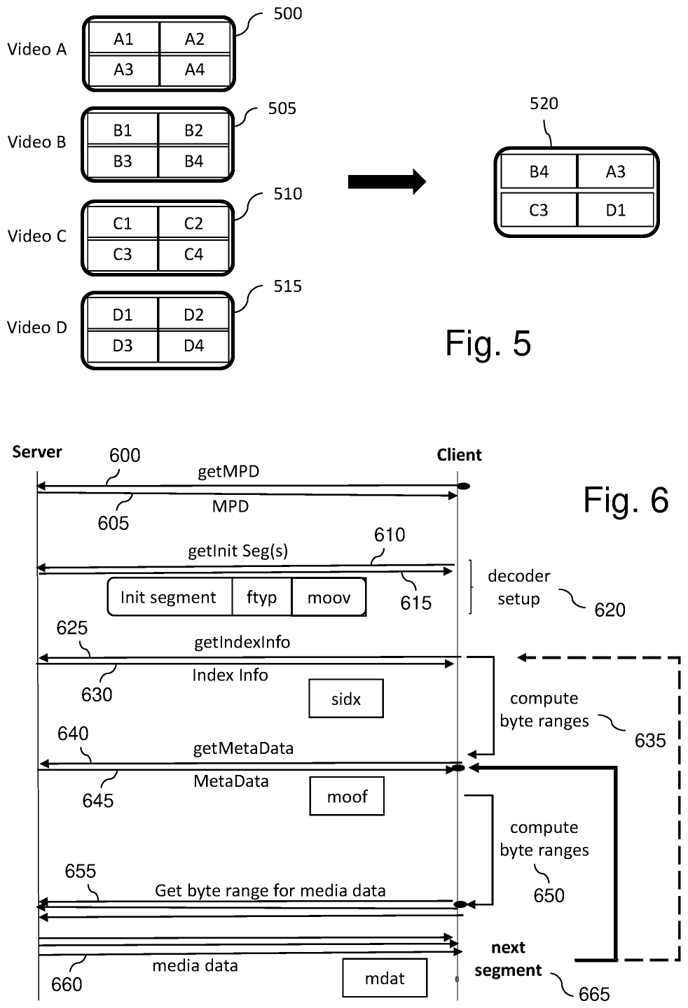

The spatial parts of the videos are encapsulated into one or more media files or media segments using an encapsulation module like the one described by reference to FIG. 1, slightly modified to handle index on metadata and index on actual data. A description of the media resource, for example a streaming manifest, is also part of the media file. The client relies on the description of the media resource included media file for selecting the data to be transmitted, using index on metadata and index on actual data, as described hereafter.

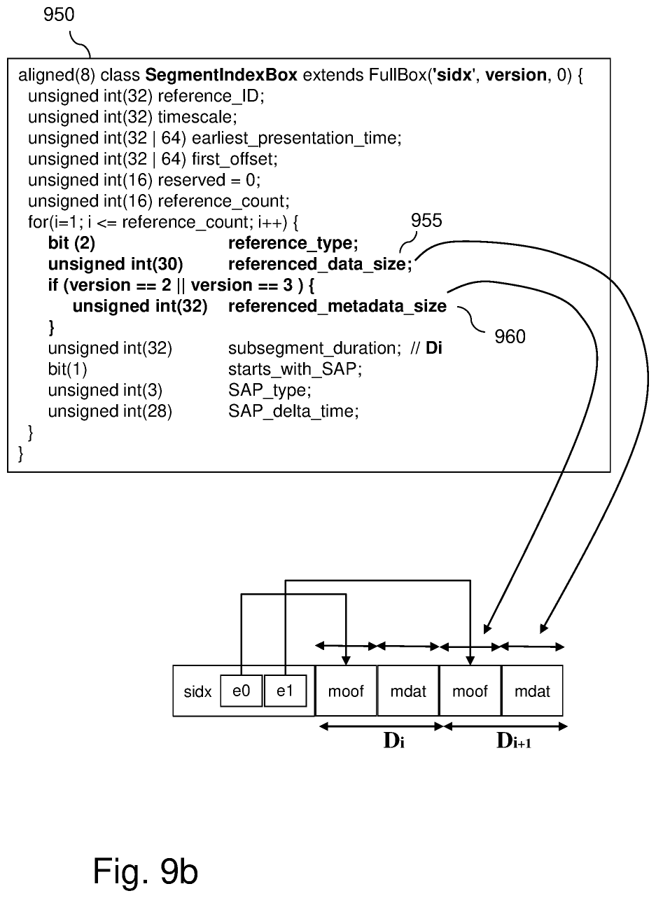

FIG. 6 illustrates requests and responses between a server and a client to obtain media data according to embodiments of the invention.

For the sake of illustration, it is assumed that the data are encapsulated in ISOBMFF and a description of the media components is available in a DASH Media Presentation Description (MPD).

As illustrated, a first request and response (steps 600 and 605) aim at providing the streaming manifest to the client, that is to say the media presentation description. From the manifest, the client can determine the initialization segments that are required to set up and initialize its decoder(s). Then, the client requests one or more of the initialization segments identified according to the selected media components through HTTP requests (step 610). The server replies with metadata (step 615), typically the ones available in the ISOBMFF ‘moov’ box and its sub-boxes. The client does the set-up (step 620) and may request index information to the server (step 625). This is the case for example in DASH profiles where Indexed Media Segments are in use, e.g. live profile. To achieve this, the client may rely on an indication in the MPD (e.g. indexRange) providing the byte range for the index information. When the media is encapsulated as ISOBMFF, the index information may correspond to the SegmentIndex box ‘sidx’. In the case according to which the media data are encapsulated as MPEG-2 TS, the indication in the MPD may be a specific URL referencing an Index Segment. Then, the client receives the requested index from the server (step 630).

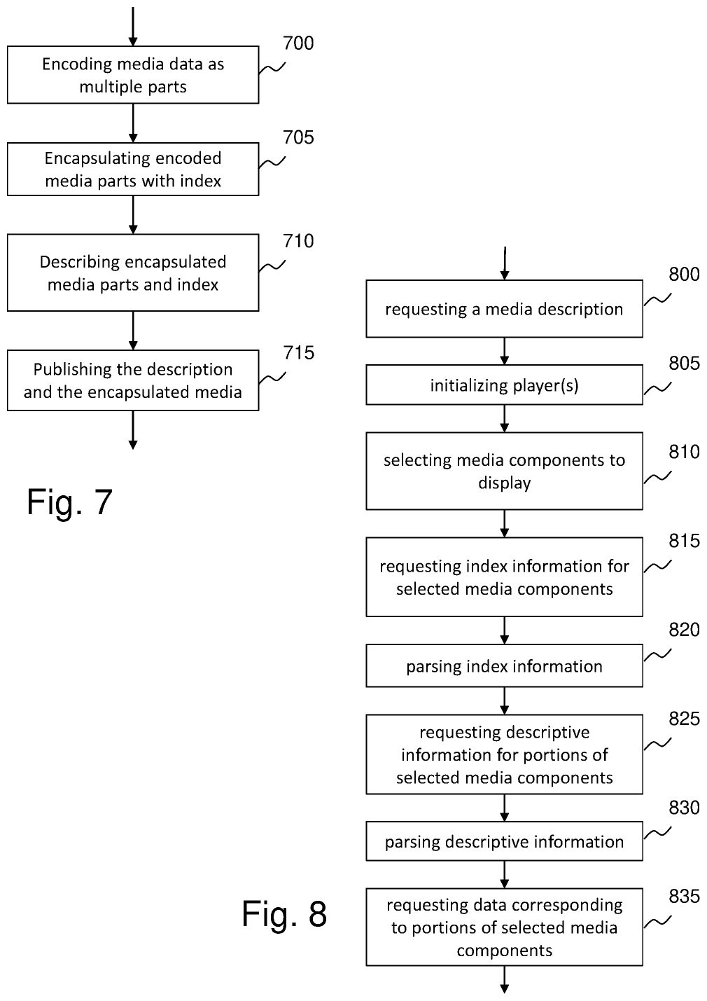

These steps are similar to steps 400 to 430 described by reference to FIG. 4.

From the received index, the client may compute byte ranges corresponding to metadata of a fragment of interest for the client (step 635). The client may issue a request with the computed byte range to get the fragment metadata for a selected media component in the MPD (step 640). The server replies to the requested movie fragment by sending the requested ‘moof’ box (step 645). When the client selects multiple media components, steps 640 and 645 respectively contain multiple requests for ‘moof’ boxes and multiple responses. For tile-based streaming, the steps 640 and 645 may correspond to request/response for a given tile, i.e. request/response on a particular track fragment box ‘traf’.

Next, using the previously received index and the received metadata, the client may compute byte ranges (step 650) to request movie fragments at a given time (e.g. corresponding to a given time range) or at a given position (e.g. corresponding to a random access point or if client is seeking). The client may issue one or more requests to get one or more movie fragments for the selected media components in the MPD (step 655). The server replies to the requested movie fragments by sending the one or more requested ‘mdaf’ boxes or byte ranges in the ‘mdat’ boxes (step 660). It is observed that the requests for the movie fragments or track fragments or more generally for the descriptive metadata may be made directly without requesting the index, for example when media segments are described as segment template and no index information is available.

Upon reception of the movie fragments, the client decodes and renders the corresponding media streams and prepares the request for the next time interval (step 665). This may consist in getting a new index, even sometimes in getting an MPD update or simply in requesting next media segments as indicated in the MPD (e.g. following a SegmentList or a SegmentTemplate description).

As illustrated with dashed arrow, the client may request a next segment index box before requesting the segment data.

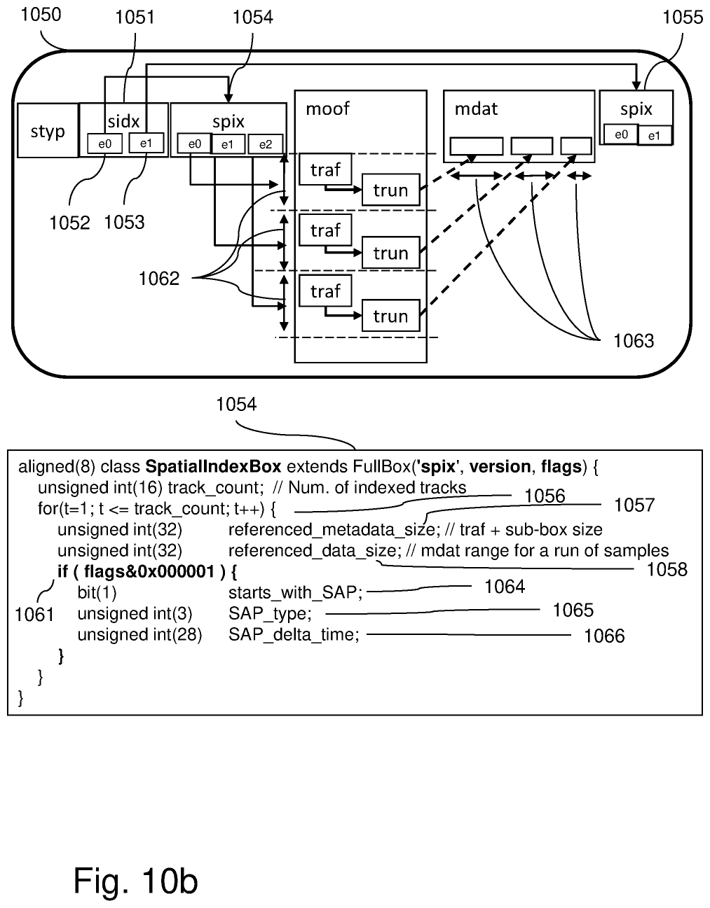

It is observed here that an advantage of using several indexes according to embodiments of the invention is to provide a client with an opportunity to refine its requests for data as depicted on the sequence diagram illustrated by reference to FIGS. 6 and 8. In comparison to the prior art, a client has the opportunity to request metadata part only (without any potentially useless actual data). The request for actual data may be determined from the received metadata. The server that encapsulated the data may set an indication in the MPD to let clients know that finer indexing is available, making it possible to request only needed actual data.

As described hereafter, there are different possibilities for the server to signal this in the MPD.

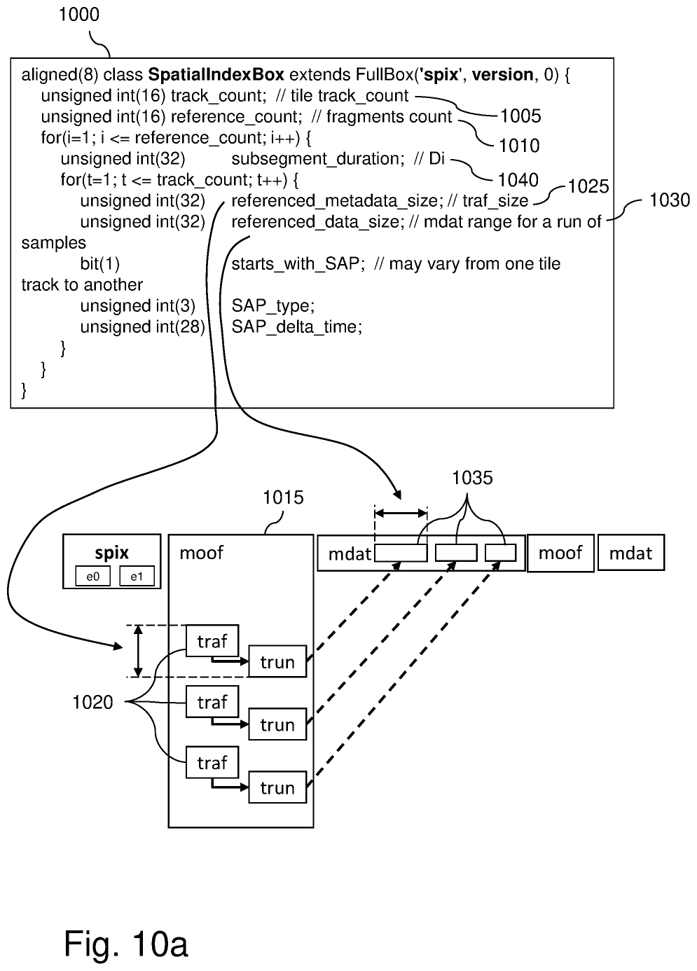

FIG. 7 is a block diagram illustrating an example of steps carried out by a server to transmit data to a client according to embodiments of the invention.

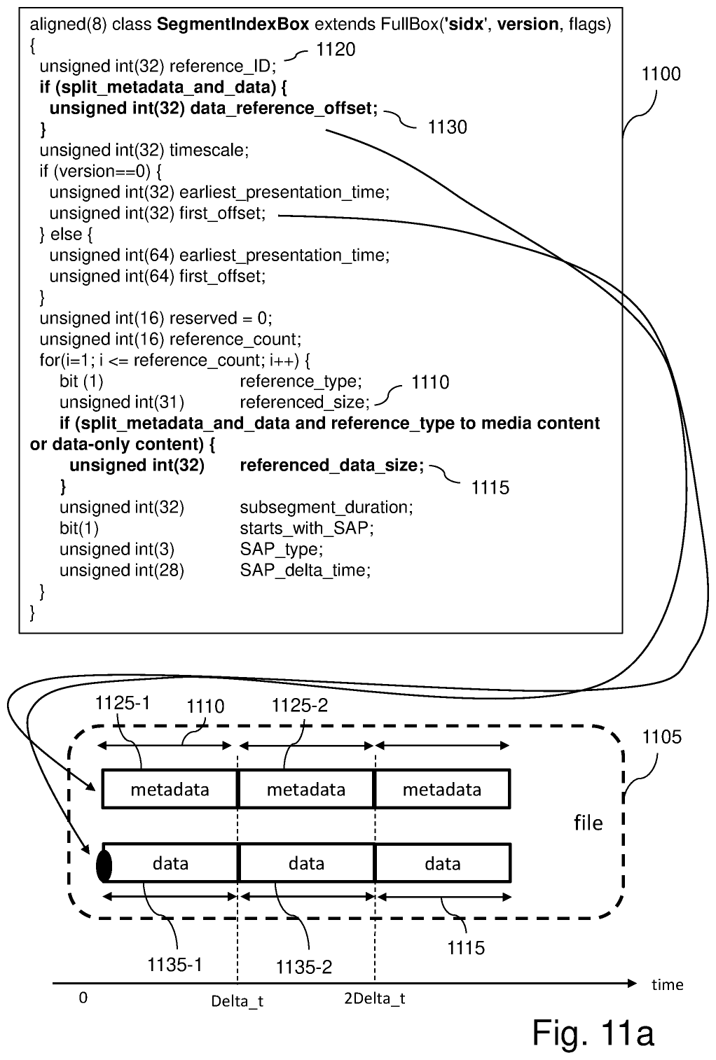

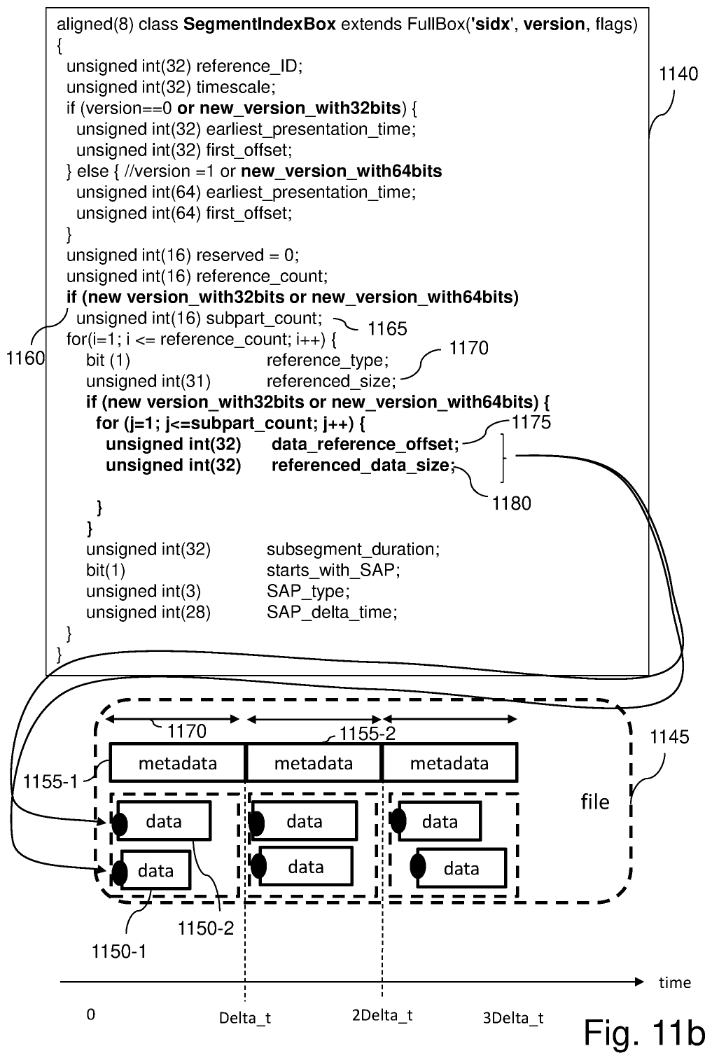

As illustrated, a first step of directed to encoding media content data as multiple parts (step 700), potentially as alternative to each other. For example, for tiled videos, one part may be a tile or a set of tiles or a group of tiles. Each part may be encoded in different versions, for example in terms of quality, resolution, etc. The encoding step results in bit-streams that are encapsulated (step 705). The encapsulation step comprises generating structured boxes containing metadata describing the placement and timing of the media data. The encapsulation step (705) may also comprise generating an index to make it possible to access metadata without accessing the corresponding actual data, as described by reference to FIGS. 9a, 9b, 10a, and 10b, (e.g. by using a modified ‘sidx’, a modified ‘spix’, or a combination thereof).

Next, one or more media files or media segments resulting from the encapsulation step are described in a streaming manifest (step 710), for example in a MPD. This step, depending on the index and on the use case (e.g. live or on-demand) uses one of the following embodiments for DASH signaling.

Next, the media files or segments with their description are published on a streaming server for diffusion to clients (step 715).

FIG. 8 is a block diagram illustrating an example of steps carried out by a client to obtain data from a server according to embodiments of the invention.

As illustrated, a first step is directed to requesting and obtaining a media presentation description (step 800). Then, the client initializes its player(s) and/or decoder(s) (step 805) by using items of information of the obtained media description.

Next, the client selects one or more media components to play from the media description (step 810) and requests information on these media components, for example index information (step 815). Then, using the index, parsed in step 820, the client may request further descriptive information, for example descriptive information of portions of the selected media components (step 825), such as metadata of one or more fragments of media components. This descriptive information is parsed by the de-encapsulation parser module (step 830) to determine byte ranges for data to request.

Next, the client issues requests on the data that are actually needed (step 835).

As described by reference to FIG. 6, this may be done in one or more requests and responses between the client and a server, depending on the index used during the encapsulation and the level of description in the media presentation description.

Accessing Metadata Using Index from the ‘Sidx’ Box

According to embodiments, metadata may be accessed by using an index obtained from the ‘sidx’ box.

FIG. 9a illustrates a first example of an extended segment index box ‘sidx’ according to embodiments of the invention, wherein new versions (denoted 905 in FIG. 9a) of the segment index box (denoted 900 in FIG. 9a) are created. According to the new versions of the segment index box, two indexes can be stored per fragment, the two indexes being different and being associated with metadata, actual data, or the set comprising the metadata and the actual data. This makes it possible for a client to request metadata and actual data separately.

According to the example of FIG. 9a, an index associated with the set comprising metadata and actual data (denoted 915) is always stored in the segment index box, in conformance with ISO/IEC 14496-12, whatever the version of the segment index box. In addition, if the version of the segment index box is a new one (i.e. the version is equal to 2 or 3 in the given example), an index associated with the metadata (denoted 920) is stored in the segment index box. Alternatively, the index stored in case the version of the segment index box is a new one may be an index associated with the actual data.

It is noted that according to this variant, the extended segment index box ‘sidx’ is able to handle earliest_presentation_time and first_offset fields, represented on 32 or 64 bits. For the sake of illustration, version type set to 0 or 1 respectively corresponds to ‘sidx’ as defined by ISO/IEC 14496-12, respectively with earliest_presentation_time and first_offset fields represented on 32 or 64 bits. New versions 2 and 3 respectively corresponds to ‘sidx’ with new field 920 providing the byte range for the metadata part of indexed movie fragments (dashed arrow).

A specific value for the reference_type, for example “moof_and _mdaf” or any reserved value, indicates that ‘sidx’ box 900 indexes both the set of metadata ‘moof’ and actual data ‘mdaf’ (through referenced_size field 915) and their sub-boxes but also the corresponding metadata part (through a referenced_metadata_size field 920). This is flexible and allows smart clients to get only the metadata part to refine their data selection request, while usual clients may request the full movie fragment using the concatenated byte ranges as referenced_size.

These new versions of ‘sidx’ box are more efficient signaling for interoperability. Indeed, when defining ISOBMFF brands supporting finer indexing, this brand may require the presence of ‘sidx’ box with new versions. Having it in a brand will let clients know whether they can handle the file or not at setup and not while parsing the index which may lead to an error after setup. This extended ‘sidx’ box can be combined with ‘sidx’ boxes of the current version, for example as in the hierarchical index or daisy-chain scheme defined in ISO/IEC 14496-12.

According to a variant of the embodiments described by reference to FIG. 9a, a new version of the ‘sidx’ box without storing any new value for the reference type (that is still coded on one bit). When reference_type indicates a movie fragment indexing, then the new version, instead of providing a single range, provides two ranges, for example one for the metadata and the actual data (‘moof’ and ‘mdaf’ parts) and one for the metadata (‘moof’ part). Accordingly, a client may request one or another or both parts depending on the level of addressing its needs. When reference_type indicates a segment index, the referenced_size could indicate the size of the indexed fragment and the referenced_data_size could indicate the size of the metadata of this indexed fragment. The new version of ‘sidx’ lets clients know what they are processing in terms of index, possibly through a corresponding ISOBMFF brand. The new version of the ‘sidx’ box can be combined with the current ‘sidx’ box version, even in an old version, for example as in the hierarchical index or daisy-chain index scheme defined in ISO/IEC 14496-12.

FIG. 9b illustrates a second example of an extended segment index box ‘sidx’ according to embodiments of the invention. As illustrated, a pair of indexes is associated with each fragment and stored in segment index box 950. According to the given example, the first index (denoted 955) is associated with the actual data of the considered fragment while the second index (denoted 960) is associated with the metadata of this fragment. Alternatively, one of these two indexes may be associated with the set comprising the metadata and the actual data of the considered fragment. Since a new field is introduced, a new version of the ‘sidx’ box is used here. To get the byte range for a fragment of metadata at a given time (i.e. to get the ‘moof’ box and its sub-boxes) a parser reads the index and increments referenced_data_size 955 and referenced_metadata_size 960 until subsegment_duration remains less than the given time. When the given time is reached, the incremental size provides the start of the fragment of metadata at a given time. Then, the referenced_metadata_size provides the number of bytes to read or to download to obtain the descriptive metadata (and only the metadata, no actual data) for a fragment at a given time

Accessing Metadata Using Spatial Index (from a ‘Spix’ Box)

FIG. 10a illustrates an example of a spatial segment index box ‘spix’ according to embodiments of the invention. Since this is a different box than the ‘sidx’ box, a particular four character code is reserved to signal and uniquely identify this box. For the sake of illustration, ‘spix’ is used (it designates spatial index).

As illustrated, ‘spix’ box 1000 indexes one or more movie fragments, the number of which being indicated by reference count field denoted 1010, for one or more referenced tracks, the number of which being indicated by the track_count field denoted 1005. In the given example, the number of tracks is equal to three. This may correspond, for example, to three tile tracks, as represented by the ‘traf’ boxes denoted 1020 in the ‘moof’ box denoted 1015.

In addition, ‘spix’ box 1000 provides two byte ranges per referenced track (e.g. per referenced tile track). According to embodiments, the first byte range indicated by referenced_metadata_size field denoted 1025 is the byte range corresponding to the metadata part, i.e. the ‘traf’ box and its sub-boxes, of the current referenced track (optionally the track_ID could be present in the box), as schematically illustrated with an arrow. The second byte range is given by the referenced_data_size field denoted 1030. It corresponds to the byte range for a contiguous byte range in the data part ‘mdat’ of the referenced fragment (like the ones referenced 1035). This byte range actually corresponds to the contiguous byte range described by the ‘trun’ box of the referenced track for the referenced fragment, as schematically illustrated with an arrow.

Optionally (not represented in FIG. 10a), the ‘spix’ box may also provide, on a track basis, information on the random access points, because they may not be aligned across tracks. A specific flags value can be allocated to indicate the presence of random access information depending on the encoding of random access. For example the ‘spix’ box may have a flag value RA_info set to 1 to indicate that the fields for SAP (Stream Access Point) are present in the box. When the flag value is not set, these parameters are not present and thus, it may be assumed that SAP information is provided elsewhere, for example through sample groups or in the ‘sidx’ box.

It is noted that, by default, tracks are indexed in increasing order of their track_ID within the ‘moof’ box. Therefore, according to embodiments, an explicit track_ID is used in the track loop (i.e. on track_count) to handle cases where the number of tracks change from one movie fragment to another (for example, there may not be all tiles available at any time by application choice, by non-detection on the content when tile is an object of interest or by encoding delay for live application). The presence or absence of the track_ID may be signaled by reserving a flags value. For example a value “track_ID_present” set to 0x2 may be reserved. When set, this value indicates that within the loop on tracks, the track_ID of the referenced tracks is explicitly provided in the ‘spix’ box. When not set, the reader shall assume that tracks are referenced in increasing order of their track_ID.

As illustrated, the ‘spix’ box may also provide the duration of a fragment (they may be aligned across tile tracks) through the subsegment_duration field denoted 1040.

It is noted that ‘spix’ boxes may be used with ‘sidx’ boxes or any other index boxes providing random access and time information, ‘spix’ boxes focusing only on spatial indexing.

FIG. 10b illustrates an example of a combination of a temporal index ‘sidx’ with a spatial index. As illustrated, a MediaSegment (reference 1050) contains a temporal index as ‘sidx’ box 1051. The ‘sidx’ box has entries illustrated with references 1052 and 1053, each pointing to a spatial index as a variant of ‘spix’ box (references 1054 or 1055).

When combined with sidx, the spatial index is simpler with a single loop on tracks (reference 1056) rather than the nested loop on fragments and on tracks as on FIG. 10a. Each entry in the ‘spix’ box (1054 or 1055) still provides the size of the track fragment box and its sub-boxes 1057 as well as the corresponding data size 1057. This enables clients to easily get byte range to access only to the metadata describing a tile track of a tiled video or a video track for a spatial part of a composite video. This kind of track is called spatial track.

When, from one spatial track to another, the position of the random access points (or stream access points) vary, their positions are given in the spatial index. This can be controlled through a value of the flags field of the ‘spix’ box. For example the ‘spix’ box (1055 or 1055) may have a flag value RA_info set to 0x000001 (or any value not conflicting with another flags' value) to indicate that the fields for SAP (Stream Access Point) are present in the box. When this flags value is not set (e.g. test referenced 1061 is false), these parameters are not present and thus, it may be assumed that SAP information from the parent ‘sidx’ box 1051 applies to all spatial tracks described in the spix box. When present (test 1061 is true), the fields related to Stream Access Point 1064, 1065 and 1066 have the same semantics as the corresponding fields in sidx.

To indicate that sidx references spatial index, a new value is used in the reference_type. In addition to values for movie fragment (reference_type=0), for segment index (1), moof_only (2) in the extended sidx, the value 3 can be used to indicate that referenced_size provides the distance in bytes from the first byte of the spatial index 1054 to the first byte of the spatial index 1055. When the spatial movie fragments (i.e. movie fragments for a spatial track) have the same duration, the duration information and the presentation time information is declared for all spatial tracks in the sidx. When the duration varies from one spatial track to another, the subsegment_duration may be declared per spatial track in the spix 1054 or 1055 instead of sidx.

Likewise, when the random access points are aligned across spatial segments, random access information is provided in the sidx and the flags of the ‘spix’ box has the value 0x000002 set to indicate an alignment of the random access point. Applied to tiled videos encapsulated in tile tracks, the reference_ID of the sidx may be set to the track_ID of the tile base track and the track count in the spix may be set to the number of tile tracks referenced with the ‘sabt’ track reference type in the TrackReferenceBox of the tile base track.

From this index, the client can easily request tile-based metadata or tile-based data or a spatial movie fragment by using sizes 1062 and 1063. This combination of ‘sidx’ and ‘spix’ provides spatio-temporal index for tile tracks and provides IndexedMediaSegment so that tiled video can be streamed efficiently with DASH.

In a variant, the ‘spix’ box is replaced by a ‘ssix’ box with its assignment type set to 2, meaning one level per tile (defined in a ‘leva’ box). This may be indexed with such a combination, for example when all tiles are in the same track and described via tile sub tracks as specified in ISO/IEC 14496-15. The ‘sidx’ maps time ranges to byte ranges while the ‘ssix’ box further provides the mapping of each tile within this time range onto a byte range. This allows clients using these two indexes to build HTTP request with byte ranges to get only one or a set of tiles from the track encapsulating all the tiles.

This combination may be useful when a track for a layer, for a sub-picture, or for one or more tiles describe a sample or a set of consecutive samples stored in a same ‘mdat’ box. When tracks for one or more tiles, layers, or sub-pictures are independently encapsulated, each in their own file or in their own ‘mdat’, the extended ‘sidx’ providing both ‘moof’ size and ‘mdat’ size may be sufficient to allow tile-based metadata access or tile-based data access or a spatial movie fragment access.

Accessing Metadata Using Index from the ‘Sidx’ Box when Metadata and Data are not Contiguous

The inventors have noted that there exist cases where it is advantageous to store metadata and data such that the metadata and the data are not contiguous, interlaced, or multiplexed (as depicted in FIG. 9a or 9b) in a media file. This is usually the case for non-fragmented ISO base media files but also for fragmented ISO base media files wherein the data part (e.g. ‘mdat’ box(es)) for a movie fragment usually follows the metadata describing this movie fragment (moor or ‘traf’ box hierarchy), as illustrated for example in FIG. 9a or 9b. Therefore, the current versions of ‘sidx’ (ISO/IEC 14496-12 5^{th} edition, December 2015) assume “self-contained” set of movie fragment boxes with the corresponding MediaDataBox(es), where a MediaDataBox containing data referenced by a MovieFragmentBox shall follow that MovieFragmentBox and shall precede the next MovieFragmentBox containing information about the same track.

According to embodiments, a new segment index box, for example a new version of the existing ‘sidx’ box, is provided to support “non-self-contained” set of one or more consecutive movie fragments. A “non-self-contained” set of consecutive movie fragments contains one or more MovieFragmentBoxes with the corresponding MediaDataBox(es) or IdentifiedMediaDataBox(es), where a MediaDataBox or IdentifiedMediaDataBox containing data referenced by a MovieFragmentBox may not follow that MovieFragmentBox and may not precede the next MovieFragmentBox containing information about the same track. For the sake of clarity, it is assumed that “consecutive” movie fragments are a sequence of movie fragments temporally ordered (according to an increasing encoding or decoding time order). For the case of tiled video and more generally of spatially split or partitioned video, “consecutive” data are data of the set of tiles or spatial parts corresponding to the same encoding or decoding time interval (or time-range). Typically, for late binding streaming, the data may correspond to a TileDataSegment while metadata may correspond to a TileIndexSegment. Advantageously, the modified segment index box according to embodiments of the invention may be embedded in TileIndexSegments, so that client can get all indexing and descriptive metadata in a reduced number of requests. As such, the data corresponding to a fragment or sub-segment may comprise one or more data blocks or chunks, each of these data blocks or chunks corresponding to a single byte range. Likewise, for example in the case of partitioned videos (such as tiled videos), the metadata corresponding to a fragment or sub-segment may comprise several ‘moof’ or ‘traf’ boxes. In such cases wherein several moof or traf boxes are associated with a fragment or sub-segment and wherein data are split into data blocks, it may be useful to associate one piece of metadata with one data-block. This can be done, for example, by encapsulating the data in an identified media data box (e.g. ‘imda’ box) taking as identifier a sequence number of the movie fragment. In such a case, the sequence number of the movie fragments is incremented not only temporally but also for each partition (e.g. for each tile, sub-picture, or layer). In the following description, the data may be contained in a classical ‘mdat’ box or in an identified media data box like ‘imda’ box.

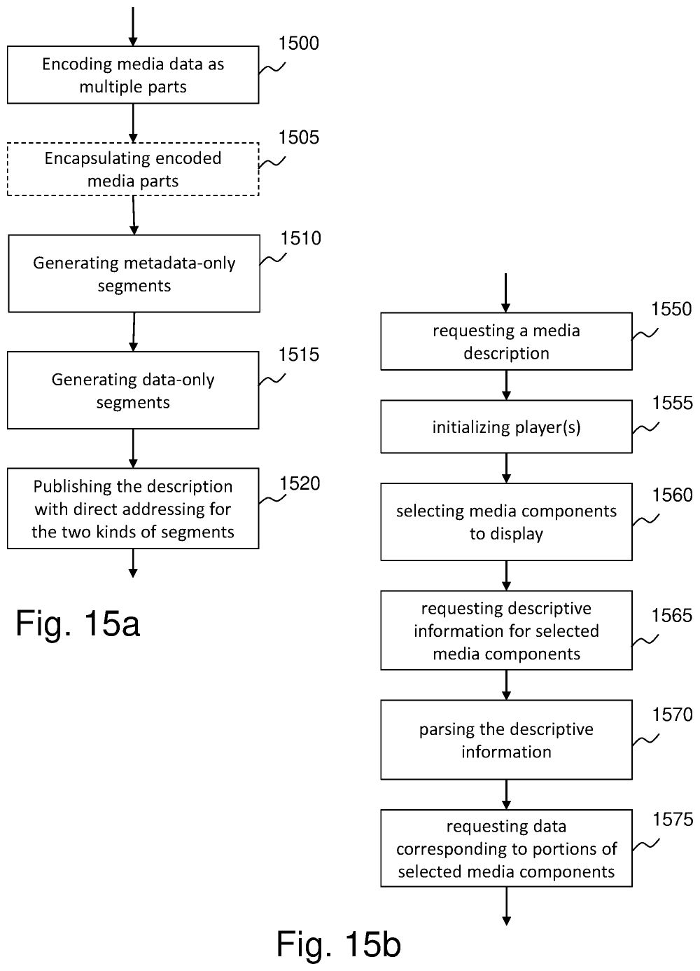

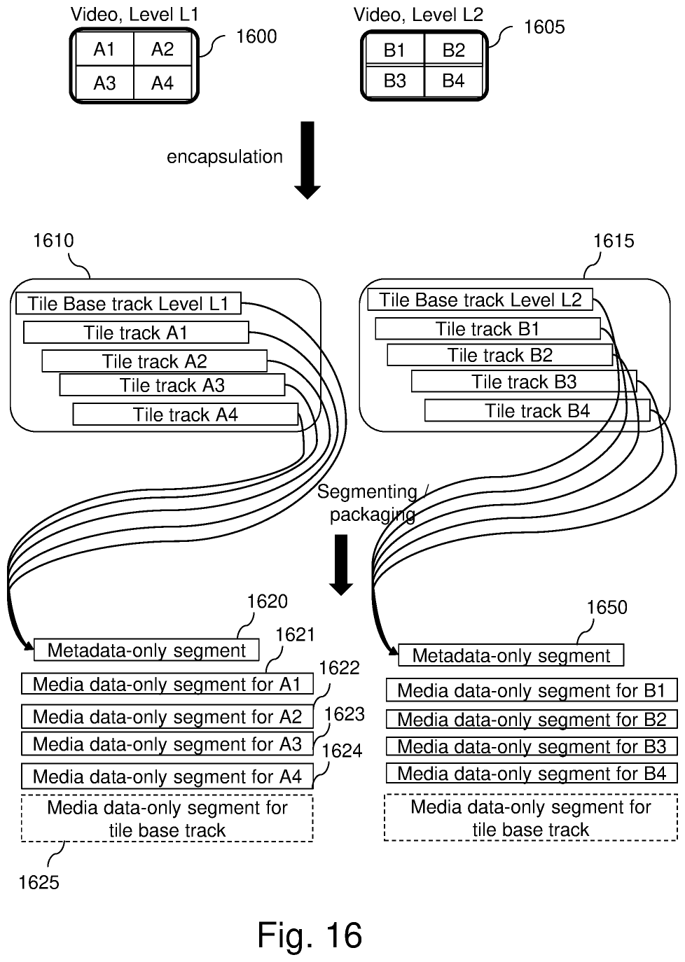

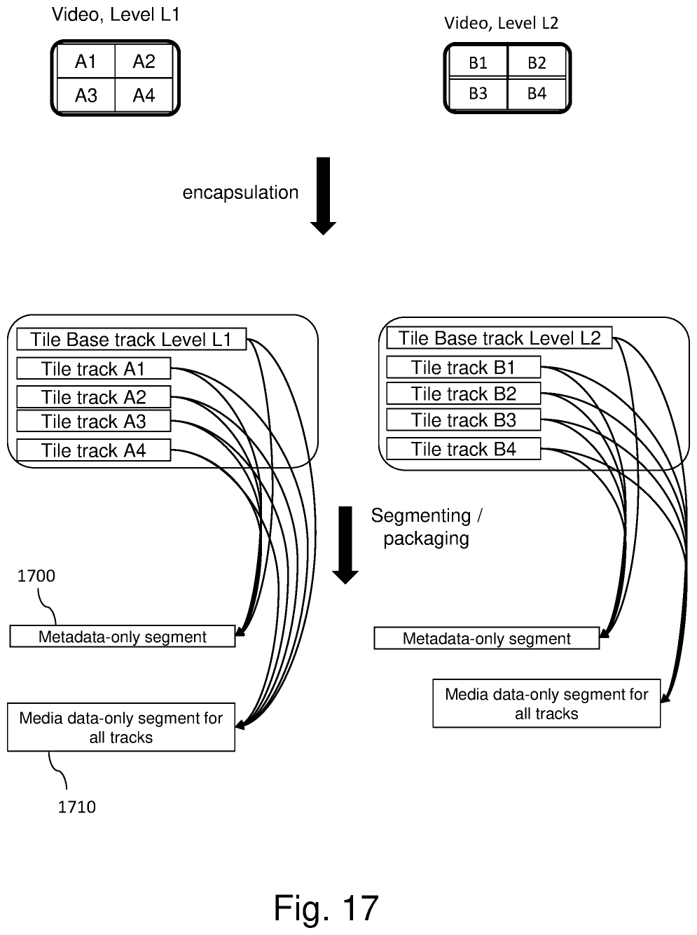

Indexing non-self-contained movie fragments may be useful for example when the media is live content encoded, encapsulated, and segmented on the fly (e.g. as described with reference to FIG. 16 or FIG. 17) for live delivery according to the DASH protocol. Then, by letting metadata-only segments and data-only segments untouched, the media may be further indexed and stored for on-demand delivery, for example as described with reference to step 1515 or 1520 in FIG. 15a. However, such indexing requires to support fragments or segments where the metadata part (e.g. ‘moof’ or ‘traf’ boxes) are not necessarily contiguous to the box(es) containing the media data (e.g. ‘mdat’ or ‘imda’). This indexing saves computation time for the encapsulation module by avoiding sample or chunk byte offsets re-computation in the sample description boxes or ‘trun’ boxes.

It is recalled here that when considering non-self-contained movie fragments, the data reference box indicates whether media data are in the same file as the metadata or not. For example, when both metadata and data are in the same file, the encapsulation module may generate (step 705) a ‘dref’ box that contains a DataEntryURLBox with the self-contained flag set and this DataEntryURLBox contains an empty URL (i.e. an empty string). When data are not in the same file as the metadata, the encapsulation module may generate (step 705) a Data Reference Box that has at least one DataEntry of type URL or URN with the self-contained flag not set and providing a non-empty URL or URN. This URL or URN indicates parsers (or de-encapsulation module 115) where to get the media data for the tracks described in the metadata part.

When data are not in the same file as the metadata and when the encapsulation module embeds the data in an identified media data box, the encapsulation module sets the self-contained flags of the corresponding DataEntries in the DataRefereceBox ‘dref’ (e.g. DataEntryImdaBox or DataEntrySeqNumImdaBox) to false. Moreover, to allow identified media data to be stored in another file, a new version of these boxes is defined, taking as additional parameter a URL or a URN to provide the location of this remote file containing the data. As a variant, when media data are in a remote file but in a single file, this can be indicated by the encapsulation module with an extra DataEntryURLBox or DataEntryURLBox with their self-contained flags not set, preferably at the last entry of the ‘dref’ box. Placing this extra DataEntryURLBox or DataEntryURNBox as the last entry in the dref box does not modify the process of any parser supporting identified media box that are contained in the same file as the metadata: they may ignore this last entry. Parsers aware of this extension shall process this extra DataEntryURLBox or DataEntryURNBox as the location for the remote file providing the identified media data boxes. For parsers to be informed on such feature and whether they should process it or not, a new brand value may be defined with the brand for identified media data box or as an additional brand to a brand for identified media data box also including support of identified media data boxes. The encapsulation module may indicate this brand in ‘ftyp’ box or ‘styp’ box.

For easier parsing and processing of the ‘sidx’ box, it may be useful to define and use some reserved flags values to indicate the actual combination in use between metadata and data: interleaved (or split) or not, in the same file or not, contiguous data or not contiguous data, etc. Indeed, while parsers (e.g. parser 115 in FIG. 1) may be informed of such parameter values from a version number of the ‘sidx’ box and the parsing of the ‘dref’ box, providing such flags or an auto-descriptive ‘sidx’ box can be useful in particular when the ‘sidx’ box is used outside of ISOBMFF. This may be the case, for example, when the segment index box is used to index MPEG-2 TS content where the ‘dref’ box would not be available. A consequence of these different configurations on the segment index is that one entry in the index may actually provide more than one byte range (as described in reference to FIGS. 9a and 9b) but also more than one reference_ID or byte offset in the considered file or may provide byte-ranges as byte-offset that is combined with a data length (and no more as a sequence of consecutive sizes as described by reference to FIGS. 9a and 9b).

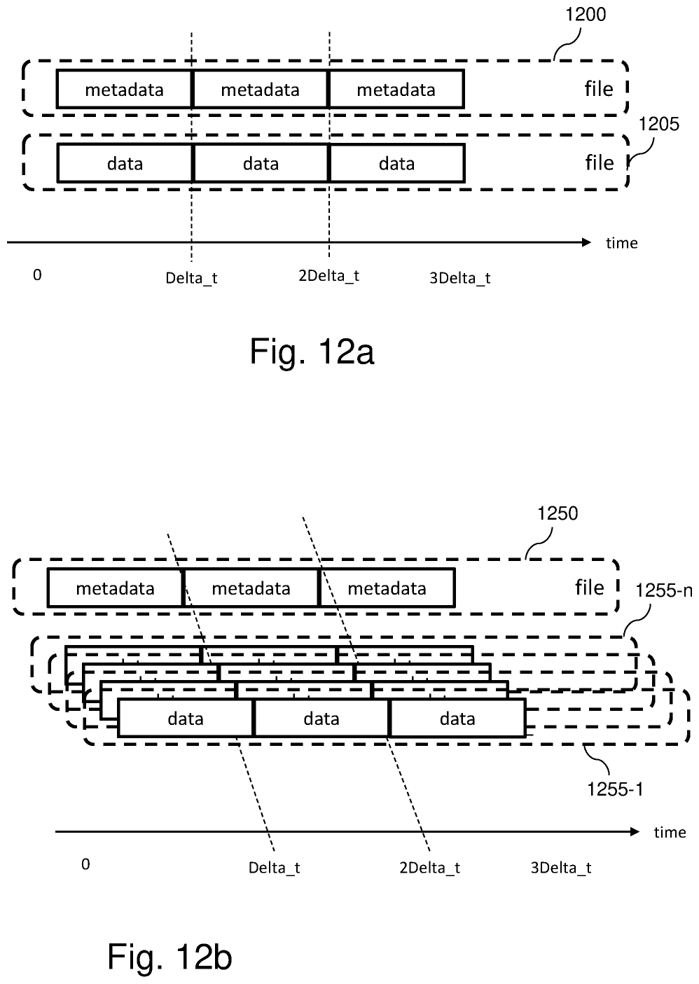

Some examples are described in more detail by reference to FIG. 11a (metadata and data are not interleaved), FIG. 11b (metadata and data are not interleaved and groups of data are not contiguous), 12a (metadata and data are stored in two different files, and 12b (metadata and data are stored in two different files and groups of data are not contiguous (and can be stored in different files)).

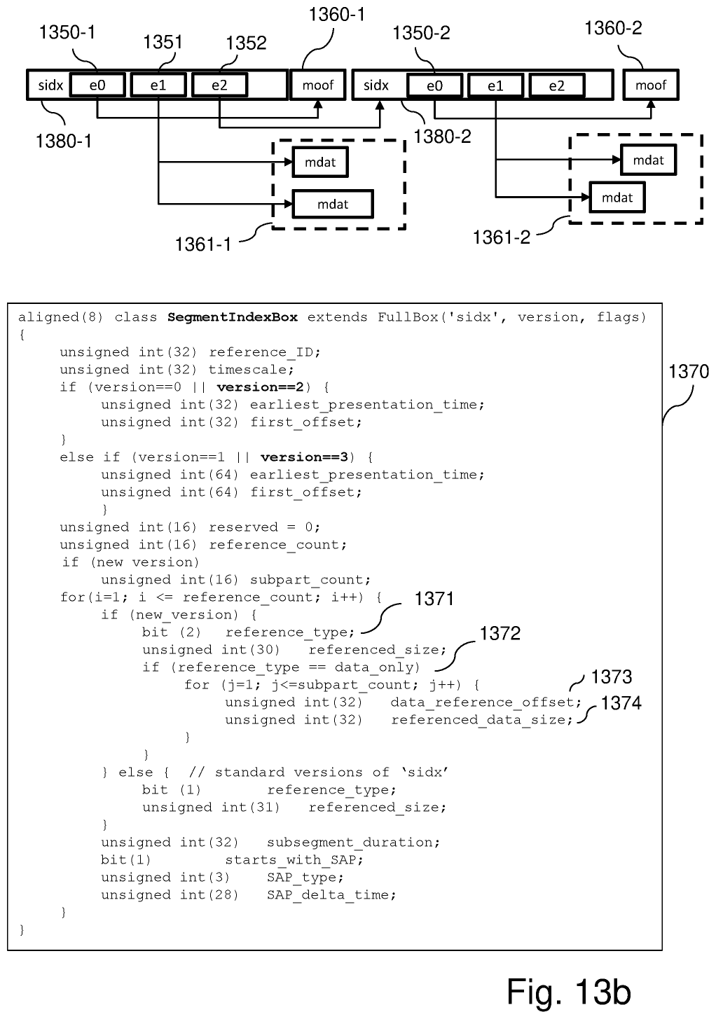

Alternatively, the data structure may be defined using a daisy-chain index as described by reference to FIGS. 13a and 13b.

FIG. 11a illustrates an example of an extended segment index box ‘sidx’ according to embodiments of the invention, enabling access to metadata and data that are not interleaved.

As illustrated, segment index box ‘sidx’ 1100 is a standard segment index box ‘sidx’ that is modified to make it possible to access metadata and data that are not interleaved (the metadata and the data being themselves contiguous). Accordingly, it may be used in a media file encapsulated with metadata and data for a given segment, fragment, or sub-segment that are split (not interleaved) but that are each contiguous in the same encapsulated media file, here the media file denoted 1105. As illustrated, the Segment Index uses two references indicating from where the referenced_size for metadata, denoted 1110 and from where the reference_data_size for data, denoted 1115, actually start in the media file 1105. The media file 1105 may contain the whole presentation file (i.e. an ISO base media file) or may be a segment file.

For the sake of illustration, the usual reference_ID field, denoted 1120, providing the track_ID of the track containing the metadata may be used in combination with the first_offset field to provide the distance, in bytes, of the first byte of the first indexed metadata denoted 1125-1. Then, by using the size 1110 of the indexed metadata, each indexed metadata, for example metadata 1125-2, may be accessed, in the media file 1105. As illustrated, a new reference denoted 1130, may be used, for example, as a byte offset in the media file 1105, to indicate from where, in the media file 1105, the indexed data, denoted 1135-1, 1135-2, etc., start. The offset is preferably determined as a function of the first byte of the file or of the first byte of the considered segment file. Then, by using the size 1115 of the indexed data, each of the indexed data, for example data 1135-2, may be accessed, in the media file 1105.

The last fields of this new segment index box describing the duration and stream access points keep the same semantics as for the standard ‘sidx’ box.

According to the example illustrated in FIG. 11a, segment index box ‘sidx’ 1100 may be included at the beginning of encapsulated media file 1105, when indexing the whole presentation.

Alternatively, several segment index boxes such as segment index box ‘sidx’ 1100 may be temporally interleaved in the encapsulated media file with the segments when not indexing the whole presentation but indexing on a segment basis.

FIG. 11b illustrates an example of an extended segment index box ‘sidx’ according to embodiments of the invention, enabling access to metadata and to data parts that are not interleaved.

As illustrated, segment index box ‘sidx’ 1140 is a standard segment index box ‘sidx’ that is modified to make it possible to access metadata and data that are not interleaved, the data being themselves not contiguous. Accordingly, it may be used in a media file encapsulated with metadata and data for a given segment, fragment, or sub-segment with data for the given segment, fragment, or sub-segment, that are split and for which data ranges may not be contiguous. According to this example, the metadata and the data are stored within a single file, for example media file 1145. The media file 1145 may contain the whole presentation file (i.e. an ISO base media file) or may be a segment file.

For example, on a given time interval (e.g. time interval [0, delta_t[), the two data blocks denoted 1150-1 and 1150-2 may comprise the encoded data for two tiles, spatial parts, or layers. The corresponding metadata, denoted 1155, may contain two ‘trun’ boxes (within one ‘moof’ box or within two ‘moof’ boxes), each describing one of the data blocks 1150-1 and 1150-2.

It is noted that when the data blocks are provided in an identifiable media data box like the ‘imda’ box, the base_offset field in the ‘trun’ box may be set to zero by the encapsulation module. Accordingly, parsers (e.g. parser 115 in FIG. 1) know that they should consider the first byte in this identifiable media data box as start offset for sample sizes. This may also be determined by the parsers by looking at the sample_description_index in the track fragment header: when referencing a data entry of type DataEntryImdaBox or DataEntrySeqNumImdaBox.

As illustrated in FIG. 11b, the segment index uses more fields than in the standard ‘sidx’ box to index such encapsulated data. These new fields can be defined and signaled by defining a new version of the ‘sidx’ (as illustrated with test 1160) or by using reserved values for the flags field of the box.

According to the illustrated embodiment, a number of sub-parts (or data parts) is provided, for example in the field referenced 1165, and the reference_type is set to a value indicating that media content is indexed. The size of both metadata (one or more movie fragment boxes) and data (one or more media data box like ‘mdat’, ‘imda’) are defined using two distinct fields denoted referenced_size and referenced_data_size and referenced 1170 and 1180, respectively. Still according to the illustrated example, referenced_size 1170 still provides the distance in bytes from the first byte of a referenced item (e.g. metadata 1155-1) to the first byte of the next referenced item (e.g. metadata 1155-2). As illustrated, the new version of the segment index box contains a loop on the sub-parts providing, for each sub-part, a start offset in the encapsulated media file 1145, referenced data_reference_offset 1175, and the size referenced_data_size 1180 of the data block, in bytes. Data_reference_offset indicates in bytes from where, in a file or in a segment file, the indexed data start. The offset is determined as a function of the first byte of the file or of the first byte of the considered segment file. Using such a ‘sidx’ box, a parser may compute the byte-range corresponding to a data block for a subpart j as [data_reference_offset[j], data_reference_offset[j]+referenced_data_size[j]]. As described above, the whole data, comprising (in this example) data parts 1150-1 and 1150-2, correspond to metadata 1155-1 and consist in multiple byte ranges.

According to other embodiments, the list of first offsets to first data blocks 1150-1 and 1150-2 is declared immediately after the declaration of the number of sub-parts 1165, to describe the start offsets for the data blocks 1175. Then, only the data block size 1180 needs to be provided within the loop on the subparts. This requires parsers to store the start offsets for the data and maintain the positions in bytes for each subpart. The byte range for data block N is obtained from the last byte of data block N−1 to this last byte position plus the current referenced_data_size 1180.

The last fields of new segment index box 1140, describing the duration and stream access points, may keep the same semantics as for the standard ‘sidx’ box, as illustrated.

As illustrated in FIG. 11b, segment index box ‘sidx’ 1100 may be included at the beginning of encapsulated media file 1145 when indexing the whole presentation.

Alternatively, several segment index boxes such as segment index box ‘sidx’ 1140 may be temporally interleaved in an encapsulated media file with the segments when not indexing the whole presentation but indexing on a segment basis.

According to the illustrated examples, it is assumed that the number of sub-parts between the different time intervals are constant. Varying number of sub-parts can be handled by inserting a subpart_count field within the first loop on reference_count.

It is observed that data_reference_offset value is preferably coded on 64 bits (rather than on 32 bits), when it is used, to match with huge files, for example with media files bigger than 4 Giga bytes.

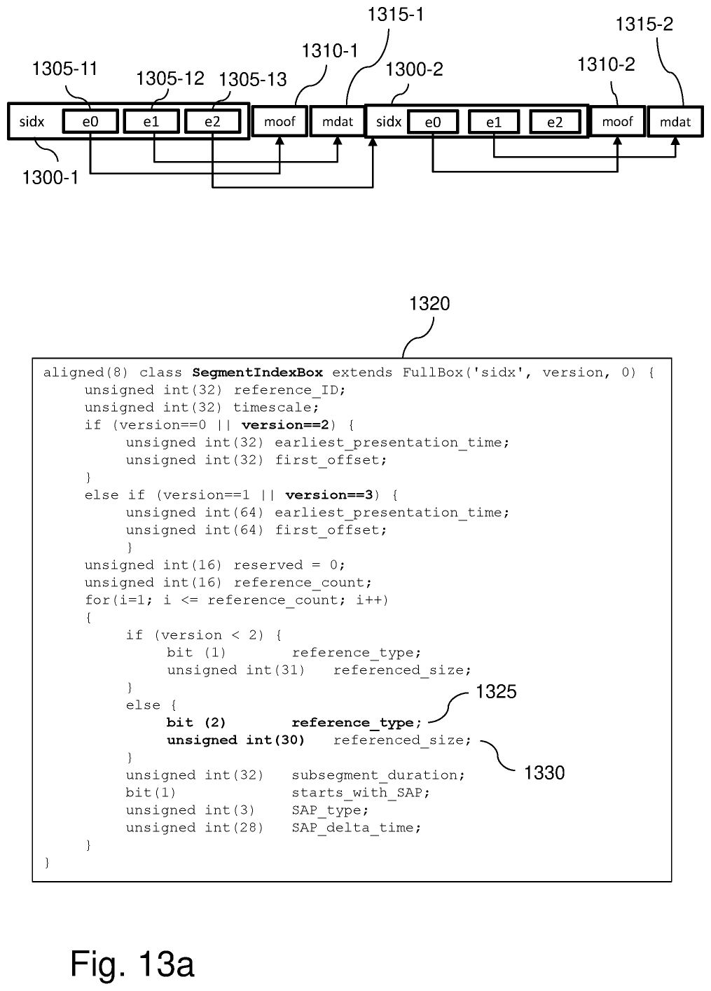

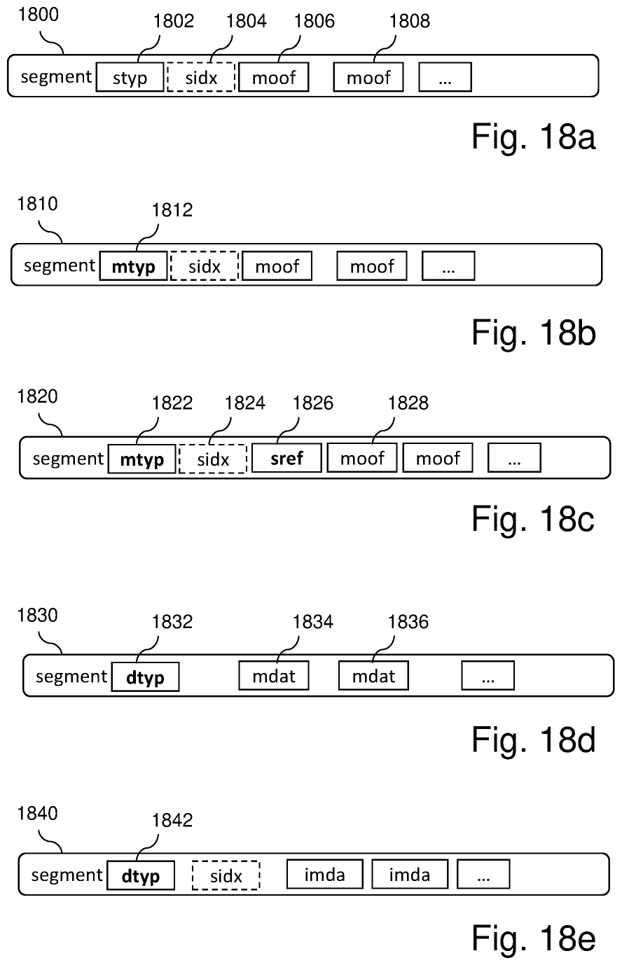

FIG. 12a is an example of media files encapsulated with metadata and data for a given segment, fragment or sub-segment that are split each in their own encapsulated media file denoted 1200 and 1205, respectively. According to the illustrated example, metadata and data are contiguous in their own encapsulated media file. The media files 1200 and 1205 are preferably segment files with an explicit segment type indication as described according to FIG. 18. For example, the file 1205 has a segment type indicating a data-only segment. Preferably, the segment index box would be embedded in the media file 1200.

A modified version of the standard segment index box ‘sidx’ can be used to define such a data structure.

According to particular embodiments, a single segment index box ‘sidx’ like segment index box ‘sidx’ 1100 in FIG. 11a is used to provide byte ranges for both metadata and data. This single segment index box ‘sidx’ is embedded within the file encapsulating the metadata, that is to say in media file 1200 according to the illustrated example. For example, in the case of late binding, this index may be embedded in a TileIndexSegment.

According to other embodiments, several segment index boxes ‘sidx’ are used, when indexing on metadata and data on a segment basis rather than on the whole presentation. The indexes may be temporally interleaved with metadata segments. According to these embodiments, the data_reference_offset (denoted 1130 in FIG. 11a) provides a track_ID, identifying the track containing the data, from which the name or the location of a file containing the data can be determined.

For determining the byte-range for the data corresponding to a metadata fragment or sub-segment, a parser (e.g. parser 115 in FIG. 1) inspects the initialization segment of the media file that is always downloaded before any index or data request (as described with reference to step 420, 620 or 1420 in FIGS. 4, 6, and 14) to initialize a player (as described with reference to step 1555 in FIG. 15). This initialization segment contains the data reference box providing the data entries with URL or URN to locate the data files for a given track or track fragment.

FIG. 12b is an example of media files encapsulated with metadata and data for a given segment, fragment or sub-segment that are split each into their own encapsulated media file(s), wherein data part are not contiguous in the same file or are split into several encapsulated media files.

Accordingly, a first file referenced 1250 contains the metadata and one second file in which the data for a given segment, sub-segment, or fragment are not contiguous (not illustrated) or several second files referenced 1255-1 to 1255-n, as illustrated.

A segment index box ‘sidx’ like segment index box ‘sidx’ 1140 in FIG. 11b may be used.

As described previously, the data_reference_offset (denoted 1175 in FIG. 11b) may be modified to provide a track_ID or an identifier of media data box rather than a byte_offset so that a parser (e.g. parser 115 in FIG. 1) can locate the media file where data to be accessed are stored (e.g. media file 1255-1) first and then the data within this file. As for previous variant, the parser relies on the data reference box to find a DataEntry providing the URL or URN to locate the data file for a given track or track fragment.

Accessing Metadata and Data Using a Daisy-Chain Index in the ‘Sidx’ Box

FIG. 13a illustrates an example of using a daisy-chain index in a segment index box ‘sidx’ to provide byte ranges for both metadata and data. According to this example, metadata and data are assumed to be in the same media file and interleaved. According to this embodiment, the existing daisy-chain index, as defined by ISO/IEC 14492-12 5^{th} edition, is extended with an additional reference_type value so that an index (reference_type=1), metadata-only (reference_type=2), and data-only (reference_type=3) are indexed alternatively for all the fragments, segments, or sub-segments, i.e. in the loop on reference_count, as illustrated in FIG. 13a.

As illustrated, each SegmentIndexBox defines a first entry pointing to metadata, a second entry pointing to data, and a third entry pointing to a following SegmentIndexBox. For example, the first entry denoted 1305-11 of a first segment index box ‘sidx’ denoted 1300-1 points to the metadata part denoted 1310-1 of the media content. According to embodiments, this may be signaled by using a dedicated reference_type value, for example a value equal to 2. Likewise, the second entry denoted 1305-12 of this segment index box points to the data part denoted 1315-1 of the media content. Again, this may be signaled by a dedicated reference_type value, for example a value equal to 3. Similarly, the third entry denoted 1305-13 points to next segment index box ‘sidx’ denoted 1300-2. Such an entry corresponds to the standard reference_type value equal to 1.

According to this embodiment and as illustrated with segment index box ‘sidx’ denoted 1320, two bits may be required for the representation of the representation_type denoted 1325, where the version value 2 may be reserved to indicate a segment index box of the new type. According to embodiments, the referenced_size field denoted 1330 may be interpreted according to the value of the reference_type.

When the reference_type is set to 1, the referenced_size may correspond to the distance in bytes from the first byte of the current segment index box ‘sidx’ to the first byte of the next segment index box ‘sidx’, for example from the first byte of segment index box ‘sidx’ 1300-1 to the first byte of segment index box ‘sidx’ 1300-2. When the reference_type is set to 2, the referenced_size may correspond to the distance in bytes from the first byte of the referenced metadata item to the first byte of the next referenced metadata item, for example from the first byte of metadata 1310-1 to the first byte of metadata 1310-2, or in the case of the last entry, the end of the referenced metadata material. When the reference_type is set to 3, the referenced_size may be the distance in bytes from the first byte of the referenced data item to the first byte of the next referenced data item, for example from the first byte of data 1315-1 to the first byte of data 1315-2, or in the case of the last entry, the end of the referenced data material.

The value of subsegment_duration of each entry with reference_type equal to 2 or 3 may correspond to the duration of the indexed fragment, sub-segment, or segment. When the reference_type is set to 1, the subsegment_duration may provide the remaining duration of the indexed fragments, sub-segments or segment in this index.

According to other embodiments, segment index box 1320 in FIG. 13a is modified to combine the standard reference_type values (1 for indexing information and 0 for media content) but contains a specific double_index (one for metadata and one for data, as described with reference to FIG. 9a or 9b) in the loop over reference_count. This double index in the loop on reference_count allows to keep on using two entries (e0 and e1) in the index instead of three for the approach described by reference to FIG. 13a. This specific segment index handles encapsulation configuration where a single file contains interleaved and contiguous metadata and data. It allows some smart clients, like in late-binding, to request metadata and data separately. This specific segment index box avoids the duplication of sub-segment duration and stream access point information in the segment index because they are provided once for a metadata and data fragment, sub-segment, or segment. When reference_type is set to 1, the semantics of subsegment_duration and stream access points remains the same as defined in ISO/IEC 14496-12. This variant may be signaled with a specific version number (as illustrated on FIG. 13a) or with one or more flags values. An alternative for signaling this variant can be the use of a specific value of reference_type indicating a double indexing (metadata and data). A list of possible reserved values with their meaning is described herein below.

FIG. 13b illustrates the use of a daisy-chain index having three entries to provide byte ranges for both metadata and data, in an encapsulation configuration where metadata and data may not be in the same file or where the data blocks for the different fragments or sub-segments of the indexed segments may not be contiguous. When not contiguous, each data block is indexed separately and the data are then available as a list of byte ranges. FIG. 13b illustrates an example of data with two data blocks that may correspond, for example, to two tiles in a video (e.g. TileDataSegment). The number of data blocks (e.g. tiles) for the indexed fragments or sub-segments is provided in the segment index box ‘sidx’ 1370 as a new field called, for example, “subpart_count”.

The example illustrated on the top of FIG. 13b, corresponding to segment index box 1370, comprises data generically referenced 1361 of a fragment or sub-segment, encapsulated into data blocks (e.g. in several ‘mdat’ or ‘imda’ boxes), and corresponding metadata, generically referenced 1360 (e.g. one or more ‘moof’ boxes), that are contiguous.

Each entry in the segment index box 1380-1 alternatively references metadata for a given fragment or sub-segment (e.g. reference 1350-1 pointing to ‘moof’ box 1360-1), one or more data blocks (e.g. reference 1361-1), and the next segment index box (e.g. reference 1380-2). The type of the referenced data is indicated by the reference_type value 1371. When reference_type indicates that only data are indexed (object of the test denoted 1372), a second loop of the segment index box, on the number of data blocks, is used to index these data blocks on the given time interval (e.g. data blocks within 1361-1) as a byte offset (e.g. data_reference_offset 1373) and a size in bytes (e.g. referenced_data_size 1374).

Optionally, the fields for sub-segment_duration and stream access points could also be controlled by the test 1372 (e.g. to be present only when reference_type indicates metadata-indexing and not declared when reference_type indicated data-indexing). This would save some description bytes by avoiding duplication between two consecutive entries e0 and e1 in the index.

When the encapsulation module creates a segment index box such as segment index box 1370, a parser can use this segment index box to get the byte-ranges for data-only by using only the second entries (reference 1351) of the segment index box, to get the metadata-only, using the first entries (reference 1350) of the segment index box, or to seek into time by using only the third entries (reference 1352) of the segment index box. According to the example illustrated in FIG. 13b, the subpart count is assumed constant from one segment to another. When the subpart count varies from one segment to another, the subpart count may be declared in the first loop on reference_count and after the test 1372.

In a variant (not represented) of the data structure illustrated in FIG. 13b, segment index box 1370 is modified to combine the standard reference_type values (1 for indexing information and 0 for media content) and a specific double_index (one for metadata and one for data, as described by reference to FIG. 11b, references 1170 and 1180) in the loop over reference_count. This specific segment index avoids the duplication of sub-segment duration and stream access point information in the segment index because they are provided once for a metadata and data fragment, sub-segment, or segment. When reference_type is set to 1, the semantics on subsegment_duration and stream access points remain the same as defined in ISOBMFF. This variant may be signaled with a specific version number (as illustrated in FIG. 13b) or with one or more flags values.

Use of ‘Sidx’ to Avoid ‘Moof’ Box Delivery

It has been observed that there exist cases where advanced clients omit downloading of MovieFragmentBoxes and create the MovieFragmentBoxes at the client's end, by parsing the high-level syntax of the received MediaDataBoxes. Media presentations may be indexed for such specific clients with an index like the SegmentIndexBox having a specific value for reference type. For example, a specific value of the reference_type is reserved to indicate that the referenced_size relates to data only. When data and metadata are interleaved, a data_reference_offset such as data_reference_offset 1175 in FIG. 11b may also be included in the loop on reference_count to not consider (or skip) the metadata in the index and provide the position in bytes to the data for the current fragment or sub-segment. Each data are then indexed as a byte offset (the data_reference_offset) plus a length in bytes (the referenced_size). The segment index may be flagged or versioned as “data-only” index or eventually defined in a new box like SegmentDataIndexBox (‘sdix’). This alternative segment index box would also provide the fields providing timing information like earliest presentation time or subsegment_duration as well as the fields providing information on the stream access points. This ‘sdix’ box may also be combined with the ‘sidx’ box, for example in the hierarchical or daisy-chain indexing.

To support the different indexing modes, the different possible reference_type values may be defined as follows:
the value 1 indicates that the reference is directed to a SegmentIndexBox. If the reference is not directed to a SegmentIndexBox, it is directed to media content as follows:
the value 0 indicates that the reference is directed to content including both metadata and media data (this may occur, for example, in the case of files comprising interleaved MovieFragmentBox and MediaDataBox). This value may be disabled in versions of sidx indicating separate indexing of data and metadata (e.g. greater than 1);
the value 2 indicates that the reference is directed to content including metadata only (this may occur, for example, in the case of files comprising one or more MovieFragmentBox for a given segment or sub-segment); this may be used in TileIndexSegments. In this case, the referenced_size is the distance in bytes from the first byte of the referenced metadata item to the first byte of the next referenced metadata item (e.g. a set of one or more consecutive moof), or in the case of the last entry, the end of the referenced metadata material;
the value 3 indicates that the reference is directed to content including media data only (this may occur, for example, in the case of files comprising one or more MediaDataBox or IdentifiedMediaDataBox for a given segment or subsegment); this may be used in TileDataSegments. In this case, the indexed size (either referenced_size or referenced_data_size when present) is the distance in bytes from the first byte of the referenced data item to the first byte of the next referenced data item (e.g. a set of one or more consecutive mdat or imda), or in the case of the last entry, the end of the referenced metadata material.

Optionally, additional values for the reference_type, using 3 bits, may be defined: a value that may be used to distinguish between indexing granularities (i.e. what does referenced_size actually correspond to) between a single ‘moof’, or one or more consecutive ‘moof’ and another value that may be used to distinguish between indexing granularities between a single media data box (e.g. ‘mdat’ or ‘imda’) or one or more consecutive media data boxes (‘mdat’ or ‘imda’).
the value 4 indicates that the reference is directed to content including metadata only (this may occur, for example, in the case of files comprising one MovieFragmentBox); in this case, the referenced_size is the distance in bytes from the first byte of the referenced metadata item to the first byte of the next referenced metadata item (e.g. one moof), or in the case of the last entry, the end of the referenced metadata material; and
the value 5 indicates that the reference is directed to content including media data only (this may occur, for example, in the case of files comprising one MediaDataBox or IdentifiedMediaDataBox). In this case, the indexed size (either referenced_size or referenced_data_size when present) is the distance in bytes from the first byte of the referenced data item to the first byte of the next referenced data item (e.g. one mdat or imda), or in the case of the last entry, the end of the referenced metadata material.

If a separate index segment is used, then entries with reference type 1, 2 or 4 are in the index segment, and entries with reference type 0 or 3 or 5 are in the media file.

These modifications of the segment index box ‘sidx’ may be referenced in DASH MPD in the index or indexRange attributes or in the Representation Index element describing the DASH segments.

As a variant of the list of reference_types, a combination of values for the flags field of the SegmentIndexBox may be advantageously used to signal the different kinds of indexing provided by a ‘sidx’ box. For example, setting a value for the flags field (for example 0x000001) for data_indexing may indicate that a referenced_size for data is available (such as reference 955, 1115, or 1180 in FIG. 9b, 11a, or 11b, respectively), for example when reference_type references media content. Likewise, setting another value for the flags field (e.g. 0x000010) for metadata_indexing may indicate that a referenced_size for metadata is available, for example when reference_type references media content. Of course, when these two values for flags are set, a parser shall interpret that the ‘sidx’ box contains a double index (one for metadata and one for data such as ‘sidx’ box 950 or 1100 in FIG. 9a or 11a, respectively). Likewise, setting another value for the flags field (e.g. 0x000100) may indicate that data and metadata are interleaved. This informs parsers that a data_reference_offset may be described in the ‘sidx’ box and considered to compute byte ranges. Additional value for the flags field (e.g. 0x001000) may indicate that data are in an external file, thus indicating the presence of a data_reference_offset to be computed from a remote file (identified from entries in the ‘dref’ box). With such a combination of flags set by the encapsulation module when indexing a media presentation, a parser is informed about the possible double referenced_sizes, first and second offsets, etc. It can then switch in a specific parsing mode and inform an application and the level of indexing: full fragment versus metadata-only or data-only so that a client, depending on this information can select a requesting strategy (e.g. one step or two-step addressing or data-only addressing).

The different index modes according to this invention may be further exposed in a streaming manifest file like the DASH Media Presentation Description. For example, index indexing the whole media presentation may be declared as a Representation Index element at the Period or at AdaptationSet level and inherited by the different Representations, for example by each Representation describing a tile or a spatial part of the video. This declaration may follow the declaration of a BaseURL for the encapsulated media file containing the metadata (‘moof’ or Ire boxes). For index indexing on a segment basis (and not the whole sequence), the index may be declared within the indexRange attribute of a SegmentBase element at the Representation level. It may be duplicated between Representations using the same index.

When the media presentation is declared within a Preselection, the Preselection element may be extended with a new “indexRange” attribute (the name being given as an example) providing a byte range for the DASH client to retrieve indexing information on the Preselection. When the index is described through a URL, the Preselection may contain an “index” attribute as an absolute URI as defined by RFC 3986 or as a relative URI with respect to a BaseURL. When present, the indexRange or index attributes overload or redefine any previous byte range or URL for index data in the parent elements. Likewise, the Preselection may be extended with a BaseURL element onto which this new index or indexRange attribute may apply. When not present, the index is applied to a BaseURL declared in a parent element of the Preselection like a Period or a MPD level. This may simplify the MPD when Preselection are used for on-demand streaming by mutualizing the URL for the different AdaptationSets and Representations contained in the Preselection. However, a BaseURL in a Preselection may be overloaded or redefined in one AdaptationSet or Representation declared in this Preselection. This still allows to mutualize the URL declaration except for some elements (AdaptationSet or Representation) of the Preselection. Optionally, when the Preselection has an index attribute present, it may also contain an “indexRangeExact” attribute that, when set to ‘true’, specifies that for all Segments in the Preselection, the data outside the prefix defined by @indexRange contains the data needed to access all access units of all media streams syntactically and semantically. It is assumed as false when not present in a Preselection element. Likewise, the Preselection element may have an @init attribute to provide the location of an initialization segment that apply to all components of the Preselection.

The DASH PreselectionType may then be specified according to the following XML Schema (the new elements or attributes being highlighted in as bold characters):

```
<xs:complexType name=“PreselectionType”>
  <xs:complexContent>
      <xs:extension base=“RepresentationBaseType”>
      <xs:sequence>
        <xs:element name=“Accessibility” type=“DescriptorType”
    minOccurs=“0” maxOccurs=“unbounded”/>
        <xs:element name=“Role”type=“DescriptorType” minOccurs=“0”
    maxOccurs=“unbounded”/>
        <xs:element name=“Rating” type=“DescriptorType” minOccurs=“0”
    maxOccurs=“unbounded”/>
        <xs:element name=“Viewpoint” type=“DescriptorType”
    minOccurs=“0” maxOccurs=“unbounded”/>
        <xs:element name=“BaseURL” type=“BaseURLType”
    minOccurs=“0” maxOccurs=“unbounded”/>
      </xs:sequence>
      <xs:attribute name=“id” type=“StringNoWhitespaceType” default=“1”/>
      <xs:attribute name=“preselectionComponents” type=“StringVectorType”
use=“required”/>
      <xs:attribute name=“lang” type=“xs:language”/>
      <xs:attribute name=“indexRange” type=“xs:string”/>
      <xs:attribute name=“index” type=“xs:anyURI”/>
      <xs:attribute name=“init” type=“xs:anyURI”/>
    </xs:extension>
  </xs:complexContent>
</xs:complexType>
```

In a variant to the above extension, the Preselection element is modified so as to possibly contain one of SegmentBase, SegmentList, or SegmentTemplate element. By doing so, it automatically inherits the index and indexRange attributes and initialization attribute or element from these segment elements as well as the inheritance and redefinition rules as defined for other AdaptationSet or Representation elements.

Using different segments for encapsulating metadata and actual data: “two-step addressing”

In order for clients to easily get the description of the different media component, it would be convenient to associate URLs to metadata-only information. When content is live content and is encoded, encapsulated on the fly for low-latency delivery, DASH uses a segment template mechanism. The Segment template is defined by the SegmentTemplate element. In this case, specific identifiers (e.g. a segment time or number) are substituted by dynamic values assigned to Segments, to create a list of Segments.

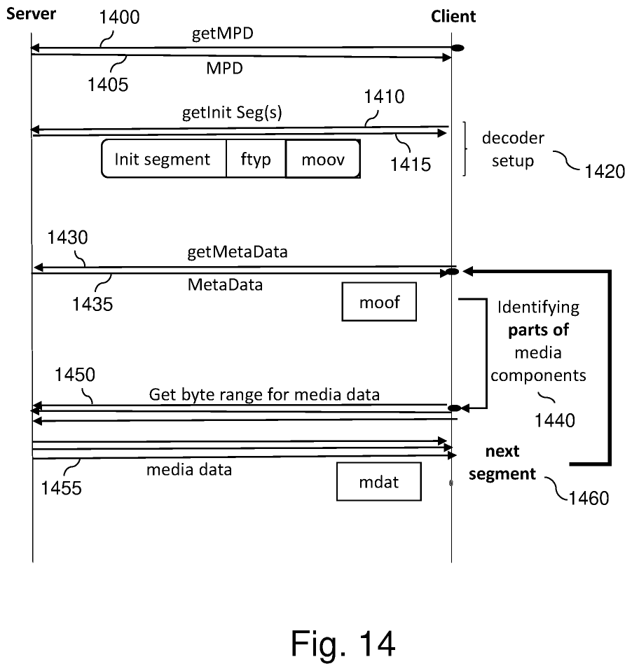

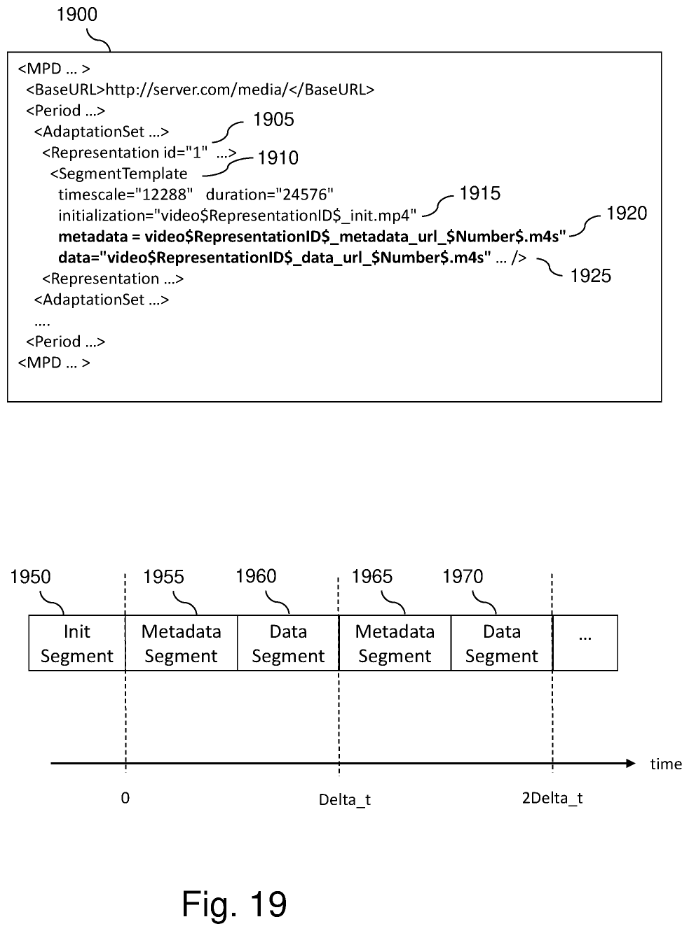

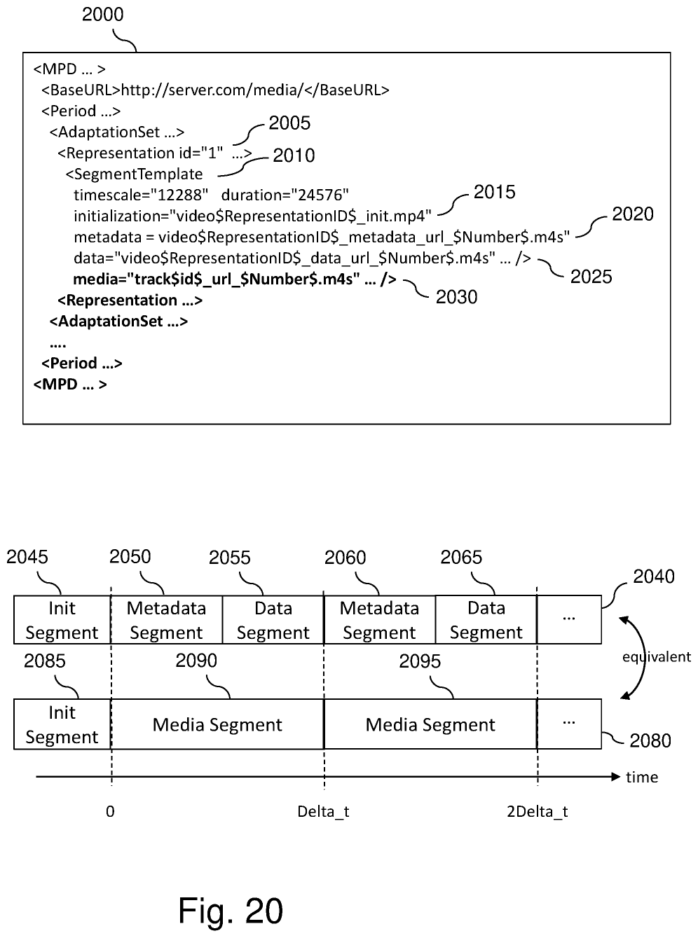

To allow efficient addressing of metadata only information (for example for saving the download of an index plus the parsing and an additional request), the server used for transmitting encapsulated media data may use a different strategy for the construction of DASH segments. In particular, the server may split an encapsulated video track into two kinds of segments exchanged over the communication network: a type of segment containing only the metadata (the “metadata only” segments) and a type of segment containing only actual data (the “media-data-only” segment). It may also encapsulate the encoded bit-stream directly into these two kinds of segments. The “metadata only” segments may be considered as Index Segments useful for clients to get a precise idea of where to find which media data. If, for backward compatibility, it is better to keep separate index segments as they are initially defined in DASH from the new “metadata-only” segments, it is possible to refer to “Metadata Segments” for these “metadata-only” segments. The general streaming process is described by reference to FIG. 14 and examples of Representation with two-step addressing are described by reference to FIG. 19 and FIG. 20.

FIG. 14 illustrates the requests and responses between a server and a client to obtain media data according to embodiments of the invention when the metadata and the actual data are split into different segments. For the sake of illustration, it is assumed that the data are encapsulated in ISOBMFF and a description of the media components is available in a DASH Media Presentation Description (MPD). As illustrated, a first request and response (steps 1400 and 1405) aims at providing the streaming manifest to the client, that is to say the media presentation description. From the manifest, the client can determine the initialization segments that are required to set up and initialize its decoder(s), depending on the media components the client selects for streaming and rendering.

Then, the client requests one or more of the identified initialization segments through HTTP requests (step 1410). The server replies with metadata (step 1415), typically the ones available in the ISOBMFF ‘moov’ box and its sub-boxes. The client does the set-up (step 1420) and may request index or descriptive metadata information from the server (step 1430) before requesting any actual data. The purpose of this step is to get the information on where to find each sample of a set of media components for a given temporal segment. This information can be seen as a “map” of the different data for the selected media components to display.

For live content, the client may also start (not represented in FIG. 14) by requesting media data for a low level (e.g. quality, bandwidth, resolution, frame rate, etc.) of the selected content to start rendering a version of the content without too much delay. In response to the request (step 1430), the server sends index or metadata information (step 1435). The metadata information is far more complete than the usual time to byte range classically provided by the ‘sidx’ box. Here, the box structure of the selected media components or even a superset of this selection is sent to the client (step 1435). Typically, this corresponds to the content of the one or more ‘moof’ boxes and their sub-boxes for the time interval covered by the segment duration. For tiled videos, it may correspond to track fragment information. When present in the encapsulated file, a segment index box (e.g. ‘sidx’ or ‘ssix’ box) may also be sent in the same response (not represented in FIG. 14).

From this information, the client can decide to get the data for some media components for the whole fragment duration or for some others to get only a subset of the media data. Depending on the manifest organization (described hereafter) the client may have to identify media components providing the actual data described in the metadata information or may simply request the data part of the segment entirely or through partial HTTP requests with byte ranges. These decisions are done during step 1440.

In embodiments, a specific URL is provided for each temporal segment to reference an IndexSegment and one or more other URLs are provided to reference the data part (i.e. a “data-only” segment). The one or more other URLs may be in the same Representation or AdaptationSet or in associated Representations or AdaptationSets also described in the MPD.

The client then issues the requests for media data (step 1450). This is the two-step addressing: getting first the metadata and from the metadata getting precise data. In response, the client receives one or more ‘mdaf’ box or bytes from ‘mdat’ box(es) (step 1455).

Upon reception of the media data, the client combines received metadata information and media data. The combined information is processed by the ISOBMFF parser to extract an encoded bit-stream handled by the video decoder. The obtained sequence of images generated by the video decoder may be stored for later use or rendered on the client's user interface. It is to be noted that for tile-based streaming or viewport dependent streaming, it is possible that the received metadata and data parts may not lead to a fully compliant ISO Base Media File but to a partial ISO Base Media File. For clients willing to record the downloaded data and to later complete the media file, the received metadata and data parts may be stored using the Partial File Format (ISO/IEC 23001/14).

The client then prepares the request for the next time interval (step 1460). This may consist in getting a new index if the client is seeking in the presentation, possibly in getting an MPD update or simply to request next metadata information to inspect next temporal segments before actually requesting media data.

It is observed here that an advantage of using two-times requesting (step 1430 and 1440) according to embodiments of the invention is to provide a client with an opportunity to refine its requests to actual data, as depicted on the sequence diagram illustrated by reference to FIGS. 14, 15a, and 15b. In comparison to the prior art, a client has the opportunity to request metadata part only, potentially from a predetermined URL (e.g. segmentTemplate) and in one request (without any potentially useless actual data). The request for actual data may be determined from the received metadata. The server that encapsulated the data may set an indication in the MPD to let clients know that requesting can be done in two steps and provide the corresponding URLs. As described hereafter, there are different possibilities for the server to signal this in the MPD.

FIG. 15a is a block diagram illustrating an example of steps carried out by a server to transmit data to a client according to embodiments of the invention. As illustrated, a first step is directed to encoding media content data as multiple parts (step 1500), potentially with alternative to each other.

The encoding step results in bit-streams that are preferably encapsulated (step 1505). The encapsulation step may comprise generating an index to make it possible to access metadata without accessing the corresponding actual data, as described by reference to FIGS. 16 to 18 (e.g. by using a modified ‘sidx’, a modified ‘spix’, or a combination thereof). The encapsulation step is followed by a segmenting or packaging step to prepare segment files for transmission over a network. According to embodiments of the invention, the server generates two kinds of segments: “metadata-only” segments and “data-only” (or “media-data-only”) segments (steps 1510 and 1515). The encapsulation and packaging steps may be performed in a single step, for example for live content transmission so as to reduce the transmission delay and end (capture at server-side) to end (display at client-side) latency.

Next, the media segments resulting from the encapsulation steps are described in a streaming manifest providing direct access to the different kinds of segments, for example in a MPD. This step uses one of the following embodiments for DASH signaling suitable for live late binding.

Next, the media files or segments with their description are published on a streaming server for making available to clients (step 1520).

FIG. 15b is a block diagram illustrating an example of steps carried out by a client to obtain data from a server according to embodiments of the invention.

As illustrated, a first step is directed to requesting and obtaining a media presentation description (step 1550). Then, the client initializes its player(s) and/or decoder(s) (step 1555) by using items of information of the obtained media description.

Next, the client selects one or more media components to play from the media description (step 1560) and requests descriptive information on these media components, for example the descriptive metadata from the encapsulation (step 1565). In embodiments of the invention, this consists in getting one or more metadata-only segments. Next, this descriptive information is parsed by the de-encapsulation parser module (step 1570) and the parsed descriptive information, optionally containing an index, is used by the client to issue requests on the data or on portions of the data that are actually needed (step 1575). For example, in the case of tiled videos, the portions of the data may consist in getting some tiles in the video.

As described by reference to FIG. 14, this may be done in one or more requests and responses between the client and a server, depending on the level of description in the media presentation description.

FIG. 16 illustrates an example of decomposition into “metadata-only” segments and “data-only” (or “media-data-only”) segments when considering for example tiled videos and tile tracks at different qualities or resolutions.

As illustrated, a first video is encoded with tiles at a given quality or resolution level, L1 (step 1600) and the same video is encoded with tiles at another quality or resolution level, L2 (step 1605). The grid of tiles may be aligned across the two levels for example when only quantization step is varying or may not be aligned, for example when the resolution changes from one level to another. For example, there may be more tiles in the high-resolution video than in the low-resolution video.

Next, each of the resolution levels (L1 and L2) is encapsulated into tracks (steps 1610 and 1615). According to embodiments, each tile is encapsulated in its own track, as illustrated in FIG. 16. In such embodiments, the tile base track in each level may be an HEVC tile base track as defined in ISO/IEC 14496-15 and tile tracks in each level may be HEVC tile tracks as defined in ISO/IEC 14496-15. Classically, when prepared for streaming with DASH, each tile or tile base track would be described in an AdaptationSet, each level potentially providing alternative Representation. The Media Segments in each of these Representation enable DASH clients to request, on a time basis, metadata and corresponding actual data for a given tile.

In a late binding approach (according to which a client is able to select and compose spatial parts (tiles) of videos to obtain and render a best video given the client context), the clients perform a two-step approach: first it gets metadata (called TileIndexSegment) then, based on the obtained metadata, it requests actual data (called TileDataSegment). It is then more convenient to organize the segments so that metadata information can be accessed in a minimum number of requests and to organize media data with granularity that enables a client to select and request only what it needs.

To that end, the encapsulation module creates, for a given resolution level, a metadata-only segment like the metadata-only segment denoted 1620 containing all the metadata (‘moof’+‘traf’ boxes) of the tracks in the set of tracks encapsulated in step 1610 and media-data-only segments, typically one per tile and optionally one for the tile base track if it contains NAL units like the media-data-only segment denoted 1625.

This can be done on the fly right after encoding (when videos encoded in steps 1600 and 1605 are only in-memory representation) or later based on a first classical encapsulation (after the encoded videos are encapsulated in steps 1610 and 1615). However, it is noted that there are advantages in keeping the encapsulated media data resulting from steps 1610 and 1615 as a valid ISO Base Media File in case the media presentation is made available for on-demand access. When the tracks of the initial set of tracks (1610 and 1615) are in the same file, a single metadata-only-segment 1620 can be used to describe all the tracks, whatever the number of levels. Segment 1650 would then be optional. A user data box may be used to indicate the levels described by this metadata-only-track, optionally with track to level mapping (track_Id, level_ID pairs). When the tracks of the initial set of tracks (1610 and 1615) are not in the same ISO Base media file, this puts more constraints on the original tracks (1610 and 1615) generation. For example, identifiers (e.g. track_IDs, track_group_id, sub-track_ID, group_IDs) should each share a same scope to avoid conflicts in identifiers.

FIG. 17 illustrates an example of decomposition of media components into one metadata-only segment (denoted 1700 in FIG. 17) and one data-only segment (denoted 1705 in FIG. 17) per resolution level. This has the advantage of not breaking offsets to samples when the initial encapsulation was in a single ‘mdaf’ box. Then, the descriptive metadata can be simply copied from initial track fragment encapsulation to the metadata-only segment. Moreover, for clients addressing and requesting data through partial HTTP requests with byte ranges, there is no penalty in describing the data as one big ‘mdat’ box as soon as they can get the metadata describing the data organization.

Definition of the New Metadata-Only-Segment

FIGS. 18a, 18, and 18c illustrate different examples of metadata-only segment.

FIG. 18a illustrates an example of a metadata-only segment 1800 identified by a ‘styp’ box 1802. A metadata-only segment contains one or more ‘moof’ boxes 1806 or 1808 but has no ‘mdat’ box. It may contain a segment index ‘sidx’ box 1804 or a sub-segment index box (not illustrated). The brands within the ‘styp’ box 1802 of a metadata-only segment may include a specific brand indicating that for transport, metadata and media data of a movie fragment are packaged in separate segments or split segments. This specific brand may be the major brand or one of the compatible brands. When used in a metadata-only segment 1800, the ‘sidx’ box 1804 indexes the moof part only in terms of duration, size and presence and types of stream access points. To avoid misunderstanding by parsers, the reference_type may use the new value for indicating that moof_only is indexed.

FIG. 18b is a variant of FIG. 18a in which, to distinguish from existing segments, a new segment type identification is used: the ‘styp’ box is replaced by an ‘mtyp’ box 1812 indicating that this segment file contain a metadata-only segment. This box has the same semantics as ‘styp’ and ‘ftyp’, the new four character codes indicating that this segment does not encapsulate a movie fragment but only its metadata. As for the variant in FIG. 18a, the metadata-only segment may contain ‘sidx’ and ‘ssix’ boxes and at least one ‘moof’ box without any ‘mdat’ box. The ‘styp’ box 1812 may contain as major brand a brand dedicated to signaling the segmentation scheme into separate segments or split segments for a same movie fragment.

FIG. 18c is another variant for metadata-only segment 1820 identified. It illustrates the presence of a new box ‘sref’ 1826 for segment reference box 1822. It is recommended to place this box before the first ‘moof’ box 1828, before or after the optional ‘sidx’ box 1824. The Segment reference box 1822 provides a list of data-only segments referenced by this metadata-only segment. This consists in a list of identifiers. These identifiers may correspond to the track_IDs from a set of associated encapsulated tracks as described by reference to steps 1610 and 1615 in FIG. 16. It is to be noted that the ‘sref’ box 1826 may be used with variants 1800 or 1810 as well.

A description of the ‘sref’ box may be as follows:

aligned(8) class SegmentReferenceBox extends Box(‘tref’) {
unsigned int(32) segment_IDs[];
}

where segment_IDs is an array of integers providing the segment identifiers of the referenced segments. The value 0 shall not be present. A given value shall not be duplicated in the array. There shall be as many values in the segment_IDs array as the number of ‘traf’ box within the ‘moof’ box. It is recommended, when from one ‘moof’ box to another the number of ‘traf’ boxes varies, to split the metadata-only-segment so that all ‘moof’ boxes within this segment have the same number of ‘traf’ box.

As an alternative to the ‘sref’ box 1826, a metadata-only segment may be associated with media-data-only segments, on a track basis, via the ‘tref’ box. Each track in the metadata-only segment is associated with the media-data-only segment it describes through a dedicated track reference type in its ‘tref’ box. For example, the four character code ‘ddsc’ may be used (any reserved and unused four character-code would work) to indicate “data description”. The ‘tref’ box of a track in a metadata-only segment contains one TrackReferenceTypeBox of type ‘ddsc’ providing the track_ID of the described media-data-only segment. There shall be only one entry in the TrackReferenceTypeBox of type ‘ddsc’ in each track of a metadata-only segment. This is because, metadata-only and media-data-only segments are time-aligned.

When used in a metadata-only segment 1800, 1810, or 1820, the ‘sidx’ box indexes only the moof part in terms of duration, size, presence, and types of stream access points. To avoid misunderstanding by parsers, the reference_type in the ‘sidx’ box may use the new value for indicating that moof_only is indexed. As well, the variants 1800, 1810, or 1820 may contain the spatial index ‘spix’ described in above embodiments. When the initial set of tracks as described by reference to steps 1610 and 1615 in FIG. 16 already contains a ‘sidx’ box in the version providing both moof and mdat size per fragment, the ‘sidx’ for the metadata-only segment can be obtained by simply keeping the moof size and ignoring the mdat size.

Definition of the Media-Data-Only-Segment

FIG. 18d illustrates an example of a “media-data-only” segment or “data-only” segment denoted 1830. The data-only segment contains a short header plus a concatenation of ‘mdaf’ boxes. The ‘mdat’ boxes may correspond to mdat from consecutive fragments of a same track. They may correspond to the ‘mdat’ boxes for the same temporal fragment from different tracks. The short header part of a data-only segment consists in a first ISOBMFF box 1832. This box allows identifying the segment as a data-only segment thanks to a specific and reserved four-character code.

In the example of segment 1830, the ‘dtyp’ box is used to indicate that the segment is a data-only segment (data-type). This box has the same semantics as the ‘ftyp’ type, i.e. provides information on the brand in use and a list of compatible brands (e.g. a brand indicating the presence of split segments or separate segments). In addition, the ‘cityp’ box contains an identifier, for example as a 32 bit-word. This identifier is used to associate a data-only segment with a metadata-only segment and more particularly with one track or track fragment description in a metadata-only segment. The identifier may be a track_ID value when the data-only segment contains data from a single track. The identifier may be the identifier of an Identified media data box ‘imda’ when used in the encapsulated tracks from which segments are built. The identifier may be optional when the data-only segment contains data from several tracks or several identified media data box, the identification being rather done in a dedicated index or through identified media data box.

FIG. 18e illustrates a “media-data-only” segment 1840 or “data-only” segment, identified by the specific box 1842, e.g. ‘dtyp’ box. This data-only segment contains identified media data boxes. This may facilitate the mapping between track fragment descriptions in a metadata-only segment to their corresponding data in one or more data-only segments.

During encapsulation step 1505, when applied to tile-based streaming, the server may use a means to associate a track fragment description to a specific ‘mdaf’ box, especially when tile tracks are encapsulated each in its own track and that packaging or segmenting steps uses one DataSegment for all tiles (as illustrated with reference 1700 in FIG. 17). This can be done by storing tile data in ‘imda’ instead of the classical mdat or in physically separate mdat boxes, each with a dedicated URL. Then, in the metadata part, the dref box may indicate that ‘imda’ are in use through DataEntryImdaBox ‘imdt’ or provide an explicit URL to the ‘mndat’ corresponding to a given track fragment for a tile track. For use cases of tile based streaming where composite videos may be reconstructed from different tiles, the ‘imda’ box may use a uuid value rather than a 32 bit word. This makes sure that when combining from different ISO Base Media files, there will be no conflicts between the identified media data boxes.

Signaling Improved Indexing in a MPD (Suitable for On-Demand Profiles)

According to embodiments, a dedicated syntax element is created in the MPD (attribute or descriptor) to provide, on a segment basis, a byte range to address metadata part only. For example, a @moof Range attribute in the SegmentBase element to expose at DASH level the byte range indexed either in extended ‘sidx’ box or in ‘spix’ box, as described above. This may be convenient when segment encapsulate one movie fragment. When segment encapsulates more than one movie fragment, this new syntax element should provide a list of byte ranges, one per fragment. The schema for the SegmentBase element is then modified as follows (the new attribute being in bold):

```
<!-- Segment information base -->
<xs:complexType name=“SegmentBaseType”>
  <xs:sequence>
    <xs:element name=“Initialization” type=“URLType” minOccurs=“0”/>
    <xs:element name=“RepresentationIndex” type=“URLType”
minOccurs=“0”/>
    <xs:any namespace=“##other” processContents=“lax” minOccurs=“0”
maxOccurs=“unbounded”/>
  </xs:sequence>
  <xs:attribute name=“timescale” type=“xs:unsignedInt”/>
  <xs:attribute name=“presentationTimeOffset” type=“xs:unsignedLong”/>
  <xs:attribute name=“presentationDuration” type=“xs:unsignedLong”/>
  <xs:attribute name=“timeShiftBufferDepth” type=“xs:duration”/>
  <xs:attribute name=“moofRange” type=“xs:string”/>
  <xs:attribute name=“indexRange” type=“xs:string”/>
  <xs:attribute name=“indexRangeExact” type=“xs:boolean” default=“false”/>
  <xs:attribute name=“availabilityTimeOffset” type=“xs:double”/>
  <xs:attribute name=“availabilityTimeComplete” type=“xs:boolean”/>
  <xs:anyAttribute namespace=“##other” processContents=“lax”/>
</xs:complexType>
```

It is noted that the “moof” box may also be ISOBMFF oriented and a generic name like “metadataRange” may be a better name. This may allow other formats than ISOBMFF to benefit from the two-step addressing as soon as they allow separation and identification of descriptive metadata from media data (e.g. Matroska or WebM” s MetaSeek, Tracks, Cues, etc. vs. Block structure).

According to other embodiments, existing syntax may be used but extended with new values. For example, the attribute indexRange may indicate the new ‘sidx’ box or the new ‘spix’ box and the indexRangeExact attribute's value may be modified to be more explicit than current value: “exact” or “not exact”. The actual type or version of index is determined when parsing the index box (e.g. ‘sidx’ or ‘spix’), but the addressing is agnostic to the actual version or type of index. For the extended values of the indexRangeExact attribute the following new set of values may be defined:
“sidx_only” (corresponding to former “exact” value),
“sidx_plus_moof_only” (the range is exact),
“moof_only” when the indexRange provides directly the byte range for moof and no more for sidx (here, the range is exact),
“sidx_plus” (corresponding to former “not exact” value), and
“sidx_plus_moof” (the range may not be exact; i.e. it may correspond to sidx+moof+some additional bytes, but includes at least sidx+moof boxes).

The XML schema for the SegmentBase@indexRangeExact element is thenmodified to support enumerated values rather than Boolean values.

A DASH descriptor may be defined for a Representation or AdaptationSet to indicate that a special index is used. For example, a SupplementalProperty with a specific and reserved scheme lets the client know that by inspecting the segment index box ‘sidx’, it may found finer indexing or that a spatial index is available. To respectively signal the two above examples, reserved scheme_id_uri values can be defined (URN values here are just examples): respectively “urn:mpeg:dash:advanced_sidx” and “urn:mpeg:dash:spatially_indexed”, with the following semantics:
the URN “urn:mpeg:dash:advanced_sidx” is defined to identify the type of segment index in use for the segments described in the DASH element containing the descriptor with this specific scheme. The attribute value is optional and when present, provides indication on whether the indexing information is exact or not and the nature of what is indexed (e.g. sidx_only, sidx_plus_moof_only, etc. as defined in the variant for indexRangeExact values). Using the descriptor's value attribute instead of modifying indexRangeExact preserves backward compatibility.
the URN “urn:mpeg:dash:spatially_indexed” is defined to indicate that the segments described in the DASH element containing the descriptor with this specific scheme contain a spatial index. For example, this descriptor may be set within AdaptationSet also containing an SRD descriptor, e.g. describing tile tracks. The value attribute of this descriptor is optional and when present may contain indication providing details on the spatial index, for example on the nature of indexed spatial parts: tiles, independent_tiles, independent bit-streams, etc.

To reinforce the backward compatibility and to avoid breaking legacy clients, these two descriptors may be written in the MPD as EssentialProperty. Doing this will guarantee that legacy client will not fail while parsing an index box it does not support.

Exposing Rearranged Segments at DASH Level (Suitable for a Late Binding Live Profile)

Other embodiments for DASH two-step addressing consist in providing URLs for both metadata-only segments and data-only segments. This may be used in a new DASH profile, for example in “late-binding” profile or “tile-based” profile where getting descriptive information on the data before actually requesting them may be useful. Such profile may be signaled in the MPD through the profile attribute of the MPD element with a dedicated URN, e.g. “urn:mpeg:dash:profile:late-binding-live:2019”. For example, this can be useful to optimize the transmitted amount of data: only useful data may be requested and sent over the network. Using distinct URLs (rather than byte ranges either directly or through an index) is useful in DASH because these URLs can be described with the DASH template mechanism. In particular, this can be useful for live streaming.

With such indication in the MPD, clients may address the metadata parts of the movie fragments, potentially saving one roundtrip (e.g. request/response for an index), as illustrated in FIG. 14.

FIG. 19 illustrates an example of an MPD denoted 1900 wherein a Representation denoted 1905 allows a two-step addressing. According to the illustrated example, Representation element 1905 is described in the MPD using the SegmentTemplate mechanism denoted 1910. It is recalled that SegmentTemplate element usually provides attributes for different kinds of segments like Initialization segment 1915, index segment or media segment.

According to embodiments, the SegmentTemplate is extended with new attributes 1920 and 1925 respectively providing construction rules for URLs to metadata-only segments and to data-only segments. This requires a segmentation as the ones described by reference to FIG. 16 or 17 where descriptive metadata and media data are separate. The names of the new attributes are provided as examples. Their semantics may be as follows:

@metadata specifies the template to create the Metadata (or “metadata-only”) Segment List. If neither the $Number$ nor the $Time$ identifier is included, this provides the URL to a Representation Index providing offsets and sizes to the different descriptive metadata for the movie fragments or for the whole file (e.g. extended sidx, spix, combination of both) and.

@data specifies the template to create the Data (or “data-only”) Segment List. If neither the $Number$ nor the $Time$ identifier is included, this provides the URL to a Representation providing offsets and sizes to the different descriptive metadata for the movie fragments or for the whole file (e.g. extended sidx, spix, combination of both).

A Representation allowing two-step addressing or a Representation suitable for late binding is organized and described such that the concatenation of their Initialization Segment, for example initialization segment 1950, followed by one or more concatenated pairs of a MetadataSegment (for example metadata segment 1955 or 1965), and a DataSegment (for example data segment 1960 or 1970), leads to a valid ISO Base Media File or to a conforming bit-stream. According to the example illustrated in FIG. 19, the concatenation of initialization segment 1950, metadata segment 1955, data segment 1960, metadata segment 1965, and data segment 1970 leads to a conforming bit-stream.

For a given segment, a client downloading the metadata segment may decide to download the whole corresponding data segment of a subpart of this data segment or even to not download any data. When applied to tile based streaming, there may be one Representation per tile. If Representations describing tiles contain the same MetadataSegment (e.g. the same URL or the same content) and are selected to be played together, only one instance of the MetadataSegment is expected to be concatenated.

It is to be noted that for tile-based streaming, the MetadataSegment may be called TileIndexSegment. Likewise, for tile-based streaming, the DataSegment may be called TileDataSegment. This instance of MetadataSegment for the current Segment shall be concatenated before any DataSegments for the selected tiles.

FIG. 20 illustrates an example of an MPD denoted 2000 wherein a Representation denoted 2005 is described as providing two-step addressing (by using attributes 2015 and 2020, as described by reference to FIG. 19) but also providing backward compatibility by providing a single URL for the whole Segment (reference 2030).

Legacy client or even smart client for late binding may decide to download the full Segment in a single roundtrip using the URL in the media attribute of SegmentTemplate 2010. Such a Representation puts some constraints on the encapsulation. The segments shall be available in two versions. The first version is the classical segment made up of one or more movie fragment version where one ‘moof’ box is immediately followed by the corresponding ‘mdat’ box. The second version is the one with split segments, one containing the moof part and the second segment containing the actual data part.

A Representation suitable for both direct addressing and two-step addressing shall satisfy the following conditions. The concatenation denoted 2040 and the concatenation denoted 2080 shall lead to equivalent bit-stream and displayed content.

Concatenation 2040 consists in the concatenation of thelnitialization Segment (initialization segment 2045 in the illustrated example) followed by one or more concatenation of pairs of a MetadataSegment (for example metadata segment 2050 or 2060) and a DataSegment (for example data segment 2055 or 2065).

Concatenation 2080 consists in the concatenation of the Initialization Segment (initialization segment 2085 in the illustrated example) with one or more Media Segment (for example media segments 2090 and 2095).

According to the embodiments described by reference to FIGS. 19 and 20, a Representation is self-contained (i.e it contains all initialization, indexing or metadata and data information).

In the case of tile based streaming, the encapsulation may use tile base track and tile tracks as illustrated in FIG. 16 or 17. The MPD may reflect this organization by providing Representation that are not self-contained. Such a Representation may be referred to as an Indexed Representation. In this case, the Indexed Representation may depend on another Representation describing the tile base track to get the Initialization information or indexing or metadata information.

The Indexed Representation may just describe how to access to the data part, for example associating a URL template to address DataSegments. The SegmentTemplate for such a Representation may contain the “data” attribute but no “metadata” attribute, i.e. does not provide a URL or URL template to access metadata segment. To make it possible to obtain the metadata segment, an Indexed Representation may contain an “indexId” attribute. Whatever the name, this new Representation's attribute, e.g. indexId, specifies the Representation describing how to access the metadata or indexing information as a whitespace-separated list of values. Most of the time there may be only one Representation declared in the indexId. Optionally, an indexType attribute may be provided to indicate the kind of index or metadata information is present in the indicated Representation.

For example, indexType may indicate “index-only” or “full-metadata”. The former indicates that only indexing information like for example sidx, extended sidx, spatial index may be available. In this case, the segments of the referenced Representation shall provide URL or byte range to access the index information. The latter indicates that the full descriptive metadata (e.g. ‘moof’ box and its sub-boxes) may be available. In this case, the segments of the referenced Representation shall provide URL or byte range to access to MetadataSegments. Depending on the type of index declared in indexType attribute, the concatenation of the segments may differ. When the referenced Representation provides access to the MetadataSegments, a segment at a given time from the referenced Representation shall be placed before any DataSegment from the IndexedRepresentations for the same given time.

In a variant, IndexedRepresentation may only reference Representation describing the MetadataSegments. In this variant, the indexType attribute may not be used. The concatenation rule is then systematic: for a given time interval (i.e. a Segment duration), the MetadataSegment from the referenced Representation is placed before the DataSegment of the IndexedRepresentation. It is recommended that segments are time aligned between IndexedRepresentation and the Representation declared in their indexId attribute. One advantage of such an organization is that a client may systematically download the segments from the referenced Representation and conditionally request data from the one or more IndexedRepresentation depending on the information obtained in the MetadataSegments and current client constraints or needs.

The reference Representation indicated in an indexId attribute may be called IndexRepresentation or BaseRepresentation. This kind or Representation may not provide any URL to data segments, but only to MetadataSegments. IndexedRepresentations are not playable by themselves and may be described as such by a specific attribute or descriptor. Their corresponding BaseRepresentation or IndexRepresentation shall also be selected. The MPD may double link IndexedRepresentation and BaseRepresentation. A BaseRepresentation may be an associatedRepresentation to each IndexedRepresentation having the id of the BaseRepresentation present in their indexId attribute. To qualify the association between a BaseRepresentation and its IndexedRepresentation, a specific unused and reserved four character code may be used in the associationType attribute of the BaseRepresentation. For example the code ‘ddsc’ for “data description”, as the one potentially used in the tref box of a “metadata-only” segment. If no dedicated code is reserved, the BaseRepresentation may be associated to IndexedRepresentation and the association type may be set to ‘cdsc’ in the associationType attribute of the BaseRepresentation.

Applied to the packaging example illustrated in FIG. 16, track 1620 may be declared in the MPD as a BaseRepresentation or IndexRepresentation while tracks 1621 to 1624 and the optional track 1625 as IndexedRepresentation, all having the id of the BaseRepresentation describing the track 1620 in their indexId attribute.

Applied to the packaging example illustrated in FIG. 17, track 1700 may be declared in the MPD as a BaseRepresentation or IndexRepresentation while track 1710 may be declared as an IndexedRepresentation having the id of the BaseRepresentation describing the track 1700 as value of its indexId attribute.

If an IndexedRepresentation is also a dependent representation (having a dependencyId set to another Representation), the concatenation rule for the dependency applies in addition to the concatenation rule for the index or metadata information. If the dependent Representation and its complementary Representation(s) share a same IndexRepresentation, then for a given segment, the MetadataSegment of the IndexRepresentation is concatenated first and once, followed by DataSegment from the complementary Representation(s) and followed by the DataSegment of the dependentRepresentation.

One example of use of the BaseRepresentation or IndexRepresentation may be the case where the metadata information for many levels of tiled videos (like video 500, 505, 510, or 515 in FIG. 5) are in a single tile base track. One BaseRepresentation may be used to describe all the metadata for all tiles across different levels. This may be convenient for clients to get in a single request all the possible spatio-temporal combinations using the different spatial tiles at different qualities or resolutions.

A MPD may mix description for tile tracks with current Representation and with Representation allowing two-step addressing. It may be useful, for example when the lower level has to be fully downloaded while upper or improvement levels may be optionally downloaded. Only the upper level may be described with two-step addressing. This makes the lower level still usable by older clients that would not support the Representation with two-step addressing. It is to be noted that the two-step addressing can also be done with SegmentList by adding a “metadata” attribute and “data” attribute of URL Type to the SegmentListType.

For client to rapidly identify IndexedRepresentation in an MPD, a specific value of the Representation's codecs attribute may be used: for example the ‘hvt2’ sample entry may be used to indicate that only data (and no descriptive metadata) are present. This avoids checking the presence of an indexId attribute or of an indexType attribute or the presence of the data attribute in their SegmentTemplate or SegmentList, or to check any DASH descriptor or Role indicating that the Representation is somehow partial since it provides access only to data (i.e. describes only DataSegments). A BaseRepresentation or IndexRepresentation for HEVC tiles may use the sample entry of an HEVC tile base track ‘hvc2’ or ‘hev2’. To describe a BaseRepresentation or IndexRepresentation as a description of a specific track, a dedicated sample entry may be used in the codecs attribute of a BaseRepresentation or IndexRepresentation, for example ‘hvit’ for “HEVC Index Track” when the media data are encoded with HEVC. It is to be noted that this mechanism could be extended to other codecs like for example the Versatile Video Coding. This specific sample entry may be set as a restricted sample entry in a tile base track during the packaging or segmenting step by the server. To keep a record of the original sample entries, the box for the definition of the restricted sample entry, an ‘rinf’ box, may be used with an OriginalFormatBox keeping track of the original sample entries, typically a ‘hvt2’ or ‘hev2’ for an HEVC tile base track.

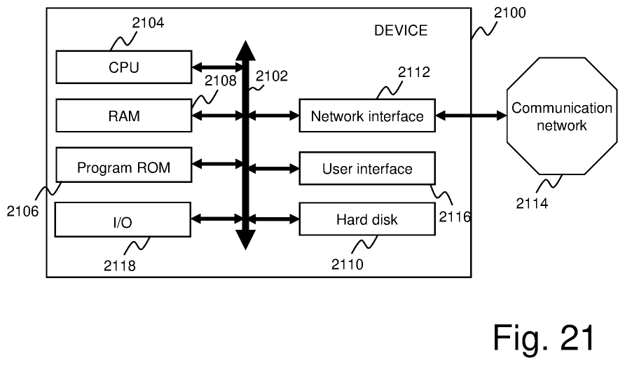

FIG. 21 is a schematic block diagram of a computing device 2100 for implementation of one or more embodiments of the invention. The computing device 2100 may be a device such as a micro-computer, a workstation or a light portable device. The computing device 2100 comprises a communication bus 2102 connected to:
a central processing unit (CPU) 2104, such as a microprocessor;
a random access memory (RAM) 2108 for storing the executable code of the method of embodiments of the invention as well as the registers adapted to record variables and parameters necessary for implementing the method for requesting, de-encapsulating, and/or decoding data, the memory capacity thereof can be expanded by an optional RAM connected to an expansion port for example;
a read only memory (ROM) 2106 for storing computer programs for implementing embodiments of the invention;
a network interface 2112 that is, in turn, typically connected to a communication network 2114 over which digital data to be processed are transmitted or received. The network interface 2112 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 2104;
a user interface (UI) 2116 for receiving inputs from a user or to display information to a user;
a hard disk (HD) 2110;
an I/O module 2118 for receiving/sending data from/to external devices such as a video source or display.

The executable code may be stored either in read only memory 2106, on the hard disk 2110 or on a removable digital medium for example such as a disk. According to a variant, the executable code of the programs can be received by means of a communication network, via the network interface 2112, in order to be stored in one of the storage means of the communication device 2100, such as the hard disk 2110, before being executed.

The central processing unit 2104 is adapted to control and direct the execution of the instructions or portions of software code of the program or programs according to embodiments of the invention, which instructions are stored in one of the aforementioned storage means. After powering on, the CPU 2104 is capable of executing instructions from main RAM memory 2108 relating to a software application after those instructions have been loaded from the program ROM 2106 or the hard-disc (HD) 2110 for example. Such a software application, when executed by the CPU 2104, causes the steps of the flowcharts shown in the previous figures to be performed.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described hereinabove with reference to specific embodiments, the present invention is not limited to the specific embodiments, and modifications will be apparent to a person skilled in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for receiving encapsulated media data provided by a server, the encapsulated media data comprising metadata and data associated with the metadata, the metadata being descriptive of the associated data, the method being carried out by the client and comprising:
obtaining, from the server, metadata associated with data; and
in response to obtaining the metadata, requesting a portion of the data associated with the obtained metadata,
wherein the data are requested independently from all the metadata with which they are associated.

2. The method of claim 1, further comprising receiving the requested portion of the data associated with the obtained metadata, the data being received independently from all the metadata with which they are associated.

3. The method of claim 1, wherein the metadata and the data are organized in segments, the encapsulated media data comprising a plurality of segments.

4. The method of claim 3, wherein at least one segment comprises metadata and at least one another segment comprises data associated with the metadata of the at least one segment for a given time range.

5. The method of claim 1, further comprising obtaining index information, the obtained metadata associated with data being obtained as a function of the obtained index information, wherein the index information comprises at least one pair of index, a pair of indexes enabling the client to locate separately metadata associated with data and the corresponding data.

6. The method of claim 1, further comprising obtaining index information, the obtained metadata associated with data being obtained as a function of the obtained index information, wherein the obtained index information comprises at least one set of pointers, a pointer of the set of pointers pointing to the metadata, a pointer of the set of pointers pointing to at least one block of corresponding data, and a pointer of the set of pointers pointing to an item of index information different from the obtained index information.

7. The method of claim 3, further comprising obtaining description information of the encapsulated media data, the description information comprising location information for locating metadata associated with data, the metadata and the data being located independently.

8. The method of claim 7, wherein at least one segment of the plurality of segments comprises only metadata associated with data.

9. The method of claim 8, wherein at least one segment of the plurality of segments comprises only data, the at least one segment comprising only data corresponding to the at least one segment comprising only metadata associated with data.

10. The method of claim 8, wherein several segments of the plurality of segments comprise only data, the several segments comprising only data corresponding to the at least one segment comprising only metadata associated with data.

11. The method of claim 5, further comprising receiving a description file, the description file comprising a description of the encapsulated media data and a plurality of links to access data of the encapsulated media data, the description file further comprising an indication that data can be received independently from all the metadata with which they are associated.

12. The method of claim 11, wherein the indexes of the pair of indexes are associated with different types of data among metadata, data, and data comprising both metadata and data and wherein the received description file further comprises a link for enabling the client to request the at least one segment of the plurality of segments comprising only metadata associated with data.

13. The method of claim 1, wherein the format of the encapsulated media data is of the ISOBMFF type, wherein the metadata descriptive of associated data belong to ‘moot boxes and the data associated with metadata belong to Imda’ boxes.

14. A method for processing received encapsulated media data provided by a server, the encapsulated media data comprising metadata and data associated with the metadata, the metadata being descriptive of the associated data, the method being carried out by the client and comprising:
receiving encapsulated media data according to the method of claim 1;
de-encapsulating the received encapsulated media data; and
processing the de-encapsulated media data.

15. A method for transmitting encapsulated media data, the encapsulated media data comprising metadata and data associated with the metadata, the metadata being descriptive of the associated data, the method being carried out by a server and comprising:
transmitting, to a client, metadata associated with data; and
in response to a request received from the client for receiving a portion of the data associated with the transmitted metadata, transmitting the portion of the data associated with the transmitted metadata,
wherein the data are transmitted independently from all the metadata with which they are associated.

16. A method for encapsulating media data, the encapsulated media data comprising metadata and data associated with the metadata, the metadata being descriptive of the associated data, the method being carried out by a server and comprising:
determining a metadata indication; and
encapsulating the metadata and data associated with the metadata as a function of the determined metadata indication so that data can be transmitted independently from all the metadata with which they are associated.

17. The method of claim 16, wherein the metadata indication comprises description information, the description information comprising location information for locating metadata associated with data, the metadata and the data being located independently.

18. (canceled)

19. A non-transitory computer-readable storage medium storing instructions of a computer program for implementing each of the steps of the method according to claim 1.

20. A device for transmitting or receiving encapsulated media data, the device comprising a processing unit configured for carrying out each of the steps of the method according to claim 1.
